(19) United States
(12) Patent Application Publication
(10) Pub. No.: US 2023/0178740 A1
(43) Pub. Date: Jun. 8, 2023

(54) BINDER COMPOSITION FOR SECONDARY BATTERY

(71) Applicant: GRST International Limited, Hong Kong (CN)

(72) Inventors: Kam Piu Ho, Hong Kong (CN); Yingkai Jiang, Shenzhen (CN); Hongke Qiu, Liannan Yao Autonomous County (CN); Tao Gong, Shenzhen (CN); Priscilla Huen, Hong Kong (CN)

(21) Appl. No.: 17/924,375

(22) PCT Filed: Jun. 10, 2021
(86) PCT No.: PCT/CN2021/099368

§ 371 Date: Nov. 10, 2022

(30) Foreign Application Priority Data
Jun. 17, 2020 (WO) PCT/CN2020/096672
Aug. 19, 2020 (WO) PCT/CN2020/110065
Sep. 25, 2020 (WO) PCT/CN2020/117789
Apr. 12, 2021 (CN) 202110393040.7

(51) Int. Cl. H01M 4/62; H01M 10/0525

(52) U.S. Cl. CPC H01M 4/622; H01M 4/624; H01M 10/0525

(57) ABSTRACT

A binder composition that can be used in a dry electrode mixture or electrode slurry for producing an electrode is disclosed. The binder composition comprises a water-compatible copolymer, and has a liquid content of less than 85%by weight, based on the total weight of the binder composition. The reduced liquid content of the binder composition improves transport and storage efficiency compared to a conventional wet binder composition. The binder composition disclosed herein is versatile, and can be used successfully in a dry electrode mixture and an electrode slurry. Batteries comprising electrodes prepared with the binder composition disclosed herein have electrochemical performances comparable to batteries comprising electrodes produced via a conventional wet binder composition.

### CROSS-REFERENCE TO RELATED APPLICATIONS

This is a U.S. national stage application of the International Patent Application No. PCT/CN2021/099368, filed Jun. 10, 2021, which claims priority to Chinese Patent Application No. 202110393040.7, filed Apr. 12, 2021, and claims the benefit under 35 U.S.C. § 365(c) of International Patent Application No. PCT/CN2020/096672, filed Jun. 17, 2020, International Patent Application No. PCT/CN2020/110065, filed Aug. 19, 2020 and International Patent Application No. PCT/CN2020/117789, filed Sep. 25, 2020, the content of all of which are incorporated herein by reference in their entireties.

### FIELD OF THE INVENTION

The present invention relates to the field of batteries. In particular, this invention relates to binder compositions that can be used in electrode slurries or dry electrode mixtures for lithium-ion batteries and other metal-ion batteries.

### BACKGROUND OF THE INVENTION

Over the past decades, lithium-ion batteries (LIBs) have become widely utilized in various applications, especially consumer electronics, because of their outstanding energy density, long cycle life and high discharging capability. Due to rapid market development of electric vehicles (EV) and grid energy storage, high-performance, low-cost LIBs are currently offering one of the most promising options for large-scale energy storage devices.

Generally, lithium-ion battery electrodes comprise an electrode active material, conductive carbon, and a binder composition. The binder composition provides a good electrochemical stability of the electrode layer, holds together the electrode layer materials and adheres the electrode layer materials to the current collector. A slurry is often used to form an electrode, wherein a solvent is used to suspend or dissolve the various electrode components for easy processing and coating. Polyvinylidene fluoride (PVDF) is one of the most commonly used binder polymers in the commercial lithium-ion battery industry, acting as a binder composition in itself, but PVDF can only dissolve in some specific organic solvents such as N-methyl-2-pyrrolidone (NMP). Accordingly, these organic solvents would be used as the solvent in electrode slurries comprising PVDF. However, NMP is flammable and toxic and hence requires specific handling. An NMP recovery system must be in place during the drying process to recover NMP vapors. This will generate significant costs in the manufacturing process since a large capital investment is required.

Considering the drawbacks of using organic solvent-based slurries to form electrodes, water-based slurries have been considered instead, wherein an aqueous solvent, most commonly water, is used in the slurry. A water-compatible binder polymer is used in a water-based electrode slurry instead of PVDF because PVDF is insoluble in water and has poor dispersion in water. Conventional methods of producing said polymer would most readily produce a binder composition that comprises the polymer and a large quantity of aqueous solvent, since a large quantity of aqueous solvent is required in the polymerization process.

When scaled up to an industrial scale, this large quantity of aqueous solvent present in the binder composition would present problems with storage, as storing even moderate quantities of the binder composition would require a large amount of space. Furthermore, in an industrial context, production of the binder composition and the electrodes may not occur in the same location, so the finished binder composition may need to be transported to another facility for electrode production. In such cases, the high liquid content would also make it difficult to move the binder composition from one facility to another. Clearly, the presence of a large quantity of aqueous solvent in the binder composition would present significant logistical challenges to efficient manufacturing of electrodes.

U.S. Pat. No. 10,741,843 discloses an electrode layer production process, wherein an electrode active material, conductive carbon, and dry PVDF as a binder composition are mixed, then calendered directly onto the current collector without the addition of any solvent. In other words, a dry electrode mixture is used to produce the electrode layer, but with the use of PVDF, a non-water-compatible polymer, is required. PVDF’s non-compatibility with water allows it to be readily obtainable in a dry state, which facilitates the making of a dry electrode mixture. This makes PVDF particularly suitable for producing dry electrode mixtures and could explain why dry PVDF was chosen to produce the dry electrode layer of the patent.

On the other hand, water-compatible polymers are not so readily available in a dry state. It is much more challenging to separate and dry water-compatible polymers to form a binder composition that is substantially free of liquid, because some water-compatible polymers irreversibly change form following drying. That is, even if rehydrated, such polymers may not return to its pre-dried form, resulting in such polymers having permanently worsened binder performance when dried. Furthermore, for some binder compositions comprising water-compatible polymers, even just reducing the liquid content of the binder composition without drying completely can be difficult, since the polymers have a high affinity for the aqueous solvent and cannot be separated from it easily.

Nonetheless, the present inventors have intensively studied on the subject, and have found that a water-compatible binder composition with a reduced liquid content (even to the point where substantially no liquid content remains) can be easily produced by processing a wet binder composition that comprises a water-compatible copolymer and an aqueous solvent, as disclosed herein. Batteries comprising electrodes produced using the binder composition disclosed herein have electrochemical performances comparable to those of batteries comprising electrodes produced using a conventional wet binder composition. Accordingly, it is an aim of the invention to present a binder composition with a reduced liquid content that comprises a water-compatible copolymer and can retain a binder performance comparable to that of a conventional wet binder composition.

### BRIEF DESCRIPTION OF THE DRAWINGS

FIG. 1 is a flow chart illustrating a summary of the various aspects disclosed herein.

### SUMMARY OF THE INVENTION

The aforementioned needs are met by various aspects and embodiments disclosed herein. In one aspect, provided herein is a binder composition that can be used in a dry electrode mixture or electrode slurry to produce an electrode, wherein the binder composition comprises a water-compatible copolymer, and wherein the binder composition has a liquid content of less than 85% by weight, based on the total weight of the binder composition. In another aspect, various dry electrode mixtures and electrode slurries utilizing such a binder composition are disclosed. Despite having a reduced liquid content, a binder composition disclosed herein can retain binder performance that is comparable to a conventional wet binder composition. Furthermore, batteries comprising electrodes produced using a binder composition disclosed herein have electrochemical performances comparable to batteries comprising electrodes produced via a wet binder composition.

### DETAILED DESCRIPTION OF THE INVENTION

In one aspect, provided herein is a binder composition that can be used in a dry electrode mixture or electrode slurry to produce an electrode, wherein the binder composition comprises a water-compatible copolymer, and wherein the binder composition has a reduced liquid content compared to a conventional wet binder composition. In another aspect, various dry electrode mixtures and electrode slurries utilizing such a binder composition are disclosed. In yet another aspect, electrodes prepared using the dry electrode mixtures and slurries are disclosed.

The term “electrode” refers to a “cathode” or an “anode.” In some embodiments, an electrode comprises of a current collector and an electrode layer.

The term “positive electrode” is used interchangeably with cathode. Likewise, the term “negative electrode” is used interchangeably with anode.

The term “current collector” refers to any conductive substrate that is in contact with an electrode layer and is capable of conducting an electrical current flowing to electrodes during discharging or charging a secondary battery. Some non-limiting examples of the current collector include a single conductive metal layer or substrate, and a single conductive metal layer or substrate with an overlying conductive coating layer, such as a carbon black-based coating layer. The conductive metal layer or substrate may be in the form of a foil or a porous body having a three-dimensional network structure, and may be a polymeric or metallic material or a metalized polymer. In some embodiments, the three-dimensional porous current collector is covered with a conformal carbon layer.

The term “electrode layer” refers to a layer that is in contact with a current collector and comprises an electrochemically active material. In some embodiments, an electrode layer is made by applying a coating on to a current collector. In some embodiments, an electrode layer is located on a surface of a current collector. In other embodiments, the three-dimensional porous current collector is coated conformally with an electrode layer.

The term “polymer” refers to a polymeric compound prepared by polymerizing monomers, whether of the same or a different type. The generic term “polymer” embraces the terms “homopolymer” as well as “copolymer”.

The term “homopolymer” refers to a polymer prepared by the polymerization of the same type of monomer.

The term “copolymer” refers to a polymer prepared by the polymerization of two or more different types of monomers. In some embodiments, the copolymer is a random copolymer, a periodic copolymer, a statistical copolymer, an alternating copolymer, a block copolymer, a stereoblock copolymer, a gradient copolymer, a graft copolymer, a star copolymer, a brush copolymer, a comb copolymer, or combinations thereof.

The term “water-compatible” with respect to a chemical compound, mixture of compounds, or polymer refers to the ability of the chemical compound, mixture of compounds, or polymer to be well dispersed in water to form a solution or colloid.

The term “binder composition” refers to a chemical compound, mixture of compounds, or polymer that is used to hold a material in place and adhere the material onto a substrate. In some embodiments, a binder composition is used to hold the electrode components in place and adhere them to a conductive metal part to form an electrode. In some embodiments, the binder composition comprises a polymer. Such a polymer can be termed a “binder polymer”. In some embodiments, the binder composition comprises a polymer that is a copolymer. Such a copolymer can be termed a “binder copolymer”. In some embodiments, the binder composition comprises a liquid, wherein the liquid is an aqueous solvent. In some embodiments, the binder composition is substantially free of liquid. In other embodiments, the binder composition does not comprise liquid.

The term “dry” in the context of a mixture means that the mixture is substantially free of or does not comprise liquid. The term “substantially free of liquid” in the context of a mixture means that the mixture has a very low liquid content. In certain embodiments, “substantially free of liquid” means that the mixture has a liquid content of less than 1%, less than 0.8%, less than 0.6%, less than 0.5%, less than 0.4%, less than 0.3%, less than 0.2%, less than 0.15%, less than 0.1%, less than 0.05%. less than 0.03%, less than 0.02%, less than 0.015%, less than 0.01%, less than 0.1%, less than 0.075%, less than 0.05%, less than 0.025%, less than 0.02%, less than 0.015%, less than 0.01%, less than 0.0075%, less than 0.005%, less than 0.0025%, less than 0.002%, less than 0.0015%, or less than 0.001% by weight, based on the total weight of the mixture.

The term “conductive agent” refers to a material that has good electrical conductivity. Therefore, a conductive agent is often mixed with an electrode active material at the time of forming an electrode to improve electrical conductivity of the electrode. In some embodiments, the conductive agent is chemically active. In some embodiments, the conductive agent is chemically inactive.

The term “dry electrode mixture” refers to a mixture of materials that can be used to form an electrode layer, wherein said mixture of materials is substantially free of or does not comprise liquid. In some embodiments, a dry electrode mixture comprises an electrode active material and a binder composition. In some embodiments, a dry electrode mixture further comprises a conductive agent.

The term “electrode slurry” refers to a mixture of materials that can be used to form an electrode layer, wherein said mixture comprises a liquid solvent. In some embodiments, an electrode slurry comprises an electrode active material and a binder composition. In some embodiments, an electrode slurry further comprises a conductive agent.

The term “particle size D50” refers to a volume-based accumulative 50% size (D50), which is a particle size at a point of 50% on an accumulative curve (i.e., a diameter of a particle in the 50th percentile (median) of the volumes of particles) when the accumulative curve is drawn so that a particle size distribution is obtained on the volume basis and the whole volume is 100%. Furthermore, with respect to the electrode active material of the present invention, the particle size D50 means a volume-averaged particle size of secondary particles which can be formed by mutual agglomeration of primary particles, and in a case where the particles are composed of the primary particles only, it means a volume-averaged particle size of the primary particles.

The term “unsaturated” as used herein refers to a moiety having one or more carbon-carbon double or triple bonds.

The term “alkyl” or “alkyl group” refers to a univalent group having the general formula CₙH₂ₙ+₁ and derived from the removal of a hydrogen atom from a saturated, unbranched or branched aliphatic hydrocarbon, where n is an integer. Examples of alkyl groups include, but are not limited to, methyl, ethyl, propyl, isopropyl, 2-methyl-1-propyl, 2-methyl-2-propyl, 2-methyl-1-butyl, 3-methyl-1-butyl, 2-methyl-3-butyl, 2,2-dimethyl-1-propyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, butyl, isobutyl, t-butyl, pentyl, isopentyl, neopentyl, hexyl, heptyl, and octyl. Longer alkyl groups include nonyl and decyl groups. An alkyl group can be unsubstituted or substituted with one or more suitable substituents. Furthermore, the alkyl group can be branched or unbranched.

The term “alkenyl” refers to a univalent group derived from the removal of a hydrogen atom from an unsaturated aliphatic hydrocarbon with at least one carbon-carbon double bond, which may be branched or unbranched. Non-limiting examples of alkenyl include vinyl, 1-propenyl, 2-propenyl, isobutenyl and butadienyl. Similarly, the term “alkynyl” refers to a univalent group derived from the removal of a hydrogen atom from an unsaturated aliphatic hydrocarbon with at least one carbon-carbon triple bond, which may be branched or unbranched. Non-limiting examples of alkenyl include ethynyl, 3-methylpent-1-yn-3-yl (HC≡C—C(CH₃)(C₂H₅)—) and butadiynyl.

The term “alkylene” refers to a saturated divalent hydrocarbon group derived from a straight or branched chain saturated hydrocarbon by the removal of two hydrogen atoms. The alkylene group is exemplified by methylene (—CH₂—), ethylene (—CH₂CH₂—), isopropylene (—CH(CH₃)CH₂—), and the like. The alkylene group is optionally substituted with one or more substituents described herein.

The term “cycloalkyl” or “cycloalkyl group” refers to a saturated or unsaturated cyclic non-aromatic hydrocarbon radical having a single ring or multiple condensed rings. Examples of cycloalkyl groups include, but are not limited to, cycloalkyl groups, such as cyclopropyl, cyclobutyl, cyclopentyl, cyclohexyl, and cycloheptyl; cycloalkenyl groups, such as cyclopropenyl, cyclobutenyl, cyclopentenyl, cyclohexenyl, and cycloheptenyl; and cyclic and bicyclic terpenes. A cycloalkyl group can be unsubstituted or substituted by one or two suitable substituents.

The term “alkoxy” refers to an alkyl group attached to the principal carbon chain through an oxygen atom. Some non-limiting examples of alkoxy groups include methoxy, ethoxy, propoxy, butoxy, and the like. An alkoxy may be substituted or unsubstituted, wherein the substituent may be, but is not limited to, deuterium, hydroxy, amino, halo, cyano, alkoxy, alkyl, alkenyl, alkynyl, mercapto, nitro, and the like.

The term “aryl” or “aryl group” refers to an organic radical derived from a monocyclic or polycyclic aromatic hydrocarbon by removing a hydrogen atom. Non-limiting examples of the aryl group include phenyl, naphthyl, benzyl, tolanyl, sexiphenyl, phenanthrenyl, anthracenyl, coronenyl, and tolanylphenyl. An aryl group can be unsubstituted or substituted with one or more suitable substituents.

The term “aliphatic” refers to a non-aromatic hydrocarbon or groups derived therefrom. Some non-limiting examples of aliphatic compounds include alkanes, alkenes, alkynes, alkyl, alkenyl, alkynyl, an alkylene group, an alkenylene group, or an alkynylene group.

The term “aromatic” refers to groups comprising aromatic hydrocarbon rings, optionally including heteroatoms or substituents. Examples of such groups include, but are not limited to, phenyl, tolyl, biphenyl, o-terphenyl, m-terphenyl, p-terphenyl, naphthyl, anthryl, phenanthryl, pyrenyl, triphenylenyl, and derivatives thereof.

The term “substituted” refers to a compound or chemical moiety where at least one hydrogen atom of that compound or chemical moiety is replaced with a second chemical moiety. This second chemical moiety is known as a “substituent”. Examples of substituents include, but are not limited to, halogen; alkyl; heteroalkyl; alkenyl; alkynyl; aryl, heteroaryl, hydroxyl; alkoxyl; amino; nitro; thiol; thioether; imine; cyano; amido; phosphonato; phosphinato; carboxyl; thiocarbonyl; sulfonyl; sulfonamide; acyl; formyl; acyloxy; alkoxycarbonyl; oxo; haloalkyl (e.g., trifluoromethyl); carbocyclic cycloalkyl, which can be monocyclic or fused or non-fused polycyclic (e.g., cyclopropyl, cyclobutyl, cyclopentyl or cyclohexyl); heterocycloalkyl, which can be monocyclic or fused or non-fused polycyclic (e.g., pyrrolidinyl, piperidinyl, piperazinyl, morpholinyl or thiazinyl);monocyclic or fused or non-fused polycyclic aryl, which can be carbocyclic or heterocyclic (e.g., phenyl, naphthyl, pyrrolyl, indolyl, furanyl, thiophenyl, imidazolyl, oxazolyl, isoxazolyl, thiazolyl, triazolyl, tetrazolyl, pyrazolyl, pyridinyl, quinolinyl, isoquinolinyl, acridinyl, pyrazinyl, pyridazinyl, pyrimidinyl, benzimidazolyl, benzothiophenyl or benzofuranyl); amino (primary, secondary or tertiary); o-lower alkyl; o-aryl, aryl; aryl-lower alkyl; —CO₂CH₃; —CONH₂; —OCH₂CONH₂; —NH₂; —SO₂NH₂; —OCHF₂; —CF₃; —OCF₃; -NH(alkyl); -N(alkyl)₂; -NH(aryl); -N(alkyl)(aryl); -N(aryl)₂; —CHO; -CO(alkyl); -CO(aryl); -CO₂(alkyl); and -CO₂(aryl); and such moieties can also be optionally substituted by a fused-ring structure or bridge, for example —OCH₂O—. These substituents can optionally be further substituted with a substituent selected from such groups. All chemical groups disclosed herein can be substituted, unless it is specified otherwise.

The term “halogen” or “halo” refers to F, Cl, Br or I.

The term “monomeric unit” refers to the constitutional unit contributed by a single monomer to the structure of a polymer.

The term “structural unit” refers to the total monomeric units contributed by the same monomer type in a polymer.

The term “number-average molecular weight” Mₙ of a polymer is defined mathematically as:

$${\text{M}}_{\text{n}} = \frac{\sum {\text{N}}_{\text{i}} {\text{M}}_{\text{i}}}{\sum {\text{N}}_{\text{i}}}$$

where Ni is the number of polymer molecules with a particular molecular weight Mi.

The term “weight-average molecular weight” M_{w} of a polymer is defined mathematically as:

$${\text{M}}_{\text{w}} = \frac{\sum {\text{N}}_{\text{i}} {\text{M}}_{\text{i}}^{2}}{\sum {\text{N}}_{\text{i}} {\text{M}}_{\text{i}}}$$

where Ni is the number of polymer molecules with a particular molecular weight Mi.

The term “polydispersity index” (PDI) of a polymer refers to the ratio of the weight-average molecular weight to the number-average molecular weight (i.e., M_{w}/Mₙ) of the polymer. It is a measure of the distribution of the molecular weight within a given polymer sample.

The term “homogenizer” refers to an equipment that can be used for the homogenization of materials. The term “homogenization” refers to a process of distributing materials uniformly throughout a mixture. Any conventional homogenizers can be used for the method disclosed herein. Some non-limiting examples of the homogenizer include stirring mixers, planetary mixers, tumblers, and mills.

The term “tumbler” refers to an equipment that can be used to mix or stir different materials to produce a homogeneous mixture, wherein the equipment comprises a vessel that rotates about a fixed axis and the vessel contains the materials to be stirred. In some embodiments, the tumbler does not contain impellers. In some embodiments, the tumbler contains free-moving components such as balls or pebbles to reduce particle aggregation. The rotation speed can be expressed in units of rotations per minute (rpm), which refers to the number of rotations that a rotating body completes in one minute.

The term “stirring mixer” refers to an equipment that can be used to mix or stir different materials to produce a homogeneous mixture, the equipment comprising one or more impellers rotating about a fixed axis within a vessel. The term “planetary mixer” refers to an equipment that can be used to mix or stir different materials to produce a homogeneous mixture, the equipment comprising two or more impellers that rotate on their own axes while also revolving continuously within the vessel. In some embodiments, the planetary mixer comprises at least one planetary blade and at least one high-speed dispersion blade as the impellers. The rotation speed can be expressed in rpm.

The term “mill” refers to an equipment that reduces the particle size of materials, the equipment comprising a mixer that can be used to mix or stir different materials for producing a homogeneous mixture. The particle size may be reduced by wearing down the particles using various objects, including but not limited to the surfaces of the vessel, pressurized gas and heavy spheres.

The term “applying” refers to an act of laying or spreading a substance on a surface.

The term “roll press” refers to an equipment that involves the use of a roller to compact a powdered material into an even coating layer. In some embodiments, the roller compacts the powder into a distinct layer, which can then be pressed onto a substrate. In some embodiments, the roller directly compacts the powder onto a substrate to form a coating layer.

The term “molding press” refers to an equipment that involves using mechanical force to create a high pressure in order to form a coating layer or pellet from powder through the use of one or more dies. In some embodiments, this force can be provided by a pneumatic or hydraulic piston. The term “tablet press” refers to a molding press that forms small pellets from powder.

The term “transfer coating” refers to a process for the fabrication of large area films on rigid or flexible substrates. Instead of coating a slurry directly onto the substrate to form the coating layer, the slurry is first coated onto a release film. The release film with the coating layer is then contacted with the substrate to allow deposition of the coating layer onto the substrate. The term “transfer coater” refers to a piece of equipment capable of conducting transfer coating.

The term “doctor blading” refers to a process for fabrication of large area films on rigid or flexible substrates. A coating blade, otherwise termed a “doctor blade”, is used to control the thickness of the coating layer by adjusting the gap width between the coating blade and the substrate surface. This allows the deposition of variable coating layer thicknesses. The term “doctor blade coater” refers to a piece of equipment capable of conducting doctor blading.

The term “slot-die coating” refers to a process for fabrication of large area films on rigid or flexible substrates. A slurry is applied to the substrate by continuously pumping slurry through a nozzle onto the substrate, which is mounted on a roller and constantly fed toward the nozzle. The thickness of the coating can be controlled by various methods, such as altering the slurry flow rate or the speed of the roller. The term “slot-die coater” refers to a piece of equipment capable of conducting slot-die coating.

The term “room temperature” refers to indoor temperatures from about 18° C. to about 30° C., e.g., 18, 19, 20, 21, 22, 23, 24, 25, 26, 27, 28, 29, or 30° C. In some embodiments, room temperature refers to a temperature of about 20° C. +/- 1° C. or +/- 2° C. or +/- 3° C. In other embodiments, room temperature refers to a temperature of about 22° C. or about 25° C.

The term “specific humidity” of a certain area refers to the mass of water vapor present per unit mass of air in that area.

The term “solid content” refers to the amount of non-volatile material in a mixture remaining after evaporation. The term “solid portion” with respect to the mixture then refers to this non-volatile material. The term “liquid content” refers to the amount of material that was evaporated from said mixture. The term “liquid portion” with respect to the mixture then refers to this evaporated material. The sum of solid content and liquid content of a mixture adds up to the total mass of said mixture. The solid content and/or liquid content of a mixture is often expressed as a proportion or percentage of the total mass of said mixture. When a mixture is free of liquid, the solid content of a mixture is 100%, while the liquid content is then 0%.

The term “peeling strength” refers to the amount of force required to separate two materials that are bonded to each other, such as a current collector and an electrode layer coated onto the current collector. It is a measure of the adhesion strength between such two materials and is usually expressed in N/cm.

The term “C rate” refers to the charging or discharging rate of a cell or battery, expressed in terms of its total storage capacity in Ah or mAh. For example, a rate of 1 C means utilization of all of the stored energy in one hour; a 0.1 C means utilization of 10% of the energy in one hour or full energy in 10 hours; and a 5 C means utilization of full energy in 12 minutes.

The term “ampere-hour (Ah)” refers to a unit used in specifying the storage capacity of a battery. For example, a battery with 1 Ah capacity can supply a current of one ampere for one hour or 0.5 A for two hours, etc. Therefore, 1 ampere-hour (Ah) is the equivalent of 3,600 coulombs of electrical charge. Similarly, the term “milliampere-hour (mAh)” also refers to a unit of the storage capacity of a battery and is 1/1,000 of an ampere-hour.

The term “capacity” is a characteristic of an electrochemical cell that refers to the total amount of electrical charge an electrochemical cell, such as a battery, is able to hold. Capacity is typically expressed in units of ampere-hours. The term “specific capacity” refers to the capacity output of an electrochemical cell, such as a battery, per unit weight, usually expressed in Ah/kg or mAh/g.

In the following description, all numbers disclosed herein are approximate values, regardless whether the word “about” or “approximate” is used in connection therewith. They may vary by 1 percent, 2 percent, 5 percent, or, sometimes, 10 to 20 percent. Whenever a numerical range with a lower limit, R^{L}, and an upper limit, R^{U}, is disclosed, any number falling within the range is specifically disclosed. In particular, the following numbers within the range are specifically disclosed: R=R^{L}+k*(R^{U}-R^{L}), wherein k is a variable ranging from 0 percent to 100 percent. Moreover, any numerical range defined by two R numbers as defined in the above is also specifically disclosed.

In the present description, all references to the singular include references to the plural and vice versa.

Currently, electrodes are often prepared by dispersing an electrode active material, a binder composition and a conductive agent in a solvent to form an electrode slurry, then coating the electrode slurry onto a current collector and drying it.

A widely-used electrode slurry formulation comprises a binder composition of PVDF and a solvent of NMP, but the use of NMP presents significant environmental, health and safety risks. In order to mitigate such risks, a vapor recovery system must be in place when using NMP, incurring additional costs. Therefore, water-based electrode slurries comprising a water-compatible binder polymer and an aqueous solvent have been proposed as a safer and more eco-friendly alternative.

However, such a water-compatible polymer may often be in the form of a wet binder composition comprising said polymer and a large quantity of aqueous solvent that originates from the production process of the polymer. This presents a problem to logistics, as the large quantity of aqueous solvent makes it difficult to store or transport the wet binder composition in any significant quantity .

For non-water-compatible polymers such as PVDF, binder compositions that are substantially free of water are readily obtainable. Indeed, such binder compositions have been successfully incorporated into dry electrode mixtures. However, transforming a wet binder composition into a dry binder composition may be difficult since the water-compatible polymer may irreversibly change form when dehydrated, resulting in worsened binder performance even if rehydrated. Due to inherent affinity of the water-compatible polymer to the aqueous solvent in the binder composition, reduction of the liquid content of a wet binder composition through the removal of aqueous solvent may be challenging.

Disclosed herein is a binder composition comprising a water-compatible copolymer, wherein the binder composition has a reduced liquid content compared to a conventional wet binder composition. In some embodiments, the binder composition is produced by processing a wet binder composition comprising said copolymer and aqueous solvent left over from the polymerization process. In some embodiments, the processed binder composition is a dry binder composition, i.e., a binder composition that is substantially free of or does not comprise liquid. In certain embodiments, the processed binder composition is a semi-dry binder composition, i.e., the binder composition still contains liquid, but the liquid content is less than that of a wet binder composition. The liquid portion of the semi-dry binder composition is referred to herein as its aqueous solvent. The binder composition disclosed in this invention was found to have excellent binder performance.

In some embodiments, the water-compatible copolymer disclosed herein is produced via polymerization of monomers, polymers or monomer-polymer complexes dispersed in an aqueous medium, the polymerization being initiated by free radicals generated by a watersoluble free radical initiator. Any suitable reaction conditions can be used in the polymerization process, as long as they result in the successful formation of the copolymer.

The aqueous medium in polymerization acts as a solvent for the free radical initiators and other chemicals required in the polymerization process. In some embodiments, the aqueous medium is water. In some embodiments, the aqueous medium is selected from the group consisting of tap water, bottled water, purified water, pure water, distilled water, deionized water (DI water), D₂O, and combinations thereof.

In some embodiments, the aqueous medium is a mixture of water and a minor component. In some embodiments, the volume ratio of water to the minor component is from about 51:49 to about 99:1. Any water-miscible solvent or volatile solvent can be used as the minor component of the aqueous medium. Some non-limiting examples of the water-miscible solvent or volatile solvent include alcohols, lower aliphatic ketones, lower alkyl acetates, and combinations thereof.

Some non-limiting examples of the alcohol include C₁-C₄ alcohols, such as methanol, ethanol, isopropanol, n-propanol, tert-butanol, n-butanol, 1,2-butanediol, 1,3-butanediol, 1,4-butanediol, 2,3-butanediol, ethylene glycol, propylene glycol, glycerol, and combinations thereof. Some non-limiting examples of the lower aliphatic ketones include acetone, dimethyl ketone, methyl ethyl ketone (MEK), and combinations thereof. Some non-limiting examples of the lower alkyl acetates include ethyl acetate (EA), isopropyl acetate, propyl acetate, butyl acetate (BA), and combinations thereof. Some other non-limiting examples of the water-miscible solvents or volatile solvents include 1,4-dioxane, diethyl ether, methyl tert-butyl ether, cyclopentyl methyl ether, tetrahydrofuran (THF), 2-methyl tetrahydrofuran, acetonitrile, dimethyl sulfoxide (DMSO), sulfolane, nitromethane, propylene carbonate, ethylene carbonate, dimethyl carbonate, pyridine, acetaldehyde, formic acid, acetic acid, propanoic acid, butyric acid, γ-valerolactone (GVL), furfuryl alcohol, methyl lactate, ethyl lactate, diethanolamine, dimethylacetamide (DMAc), dimethylformamide (DMF), N-methylpyrrolidone (NMP), dihydrolevoglucosenone (Cyrene™), N,N′-dimethylpropyleneurea (DMPU), and dimethyl isosorbide (DMI). In some embodiments, no minor component is present in the aqueous medium.

In some embodiments, the water-compatible copolymer comprises a structural unit (a) that is derived from an acid group-containing monomer, wherein the acid group is selected from the group consisting of carboxylic acid, sulfonic acid, sulfuric acid, phosphonic acid, phosphoric acid, nitric acid, salts of these acids, derivatives of these acids, and combinations thereof. In some embodiments, the salt of the acid comprises an alkali metal cation. Examples of the alkali metal include lithium, sodium, and potassium. In some embodiments, the salt of the acid comprises an ammonium cation. In some embodiments, the acid group is specifically a combination of one or more of the above acids and one or more salts of the above acids.

In some embodiments, the carboxylic acid is acrylic acid, methacrylic acid, crotonic acid, 2-butyl crotonic acid, cinnamic acid, maleic acid, maleic anhydride, fumaric acid, itaconic acid, itaconic anhydride, tetraconic acid, or combinations thereof. In certain embodiments, the carboxylic acid is 2-ethylacrylic acid, isocrotonic acid, cis-2-pentenoic acid, trans-2-pentenoic acid, angelic acid, tiglic acid, 3,3-dimethyl acrylic acid, 3-propyl acrylic acid, trans-2-methyl-3-ethyl acrylic acid, cis-2-methyl-3-ethyl acrylic acid, 3-isopropyl acrylic acid, trans-3-methyl-3-ethyl acrylic acid, cis-3-methyl-3-ethyl acrylic acid, 2-isopropyl acrylic acid, trimethyl acrylic acid, 2-methyl-3,3-diethyl acrylic acid, 3-butyl acrylic acid, 2-butyl acrylic acid, 2-pentyl acrylic acid, 2-methyl-2-hexenoic acid, trans-3-methyl-2-hexenoic acid, 3-methyl-3-propyl acrylic acid, 2-ethyl-3-propyl acrylic acid, 2,3-diethyl acrylic acid, 3,3-diethyl acrylic acid, 3-methyl-3-hexyl acrylic acid, 3-methyl-3-tert-butyl acrylic acid, 2-methyl-3-pentyl acrylic acid, 3-methyl-3-pentyl acrylic acid, 4-methyl-2-hexenoic acid, 4-ethyl-2-hexenoic acid, 3-methyl-2-ethyl-2-hexenoic acid, 3-tert-butyl acrylic acid, 2,3-dimethyl-3-ethyl acrylic acid, 3,3-dimethyl-2-ethyl acrylic acid, 3-methyl-3-isopropyl acrylic acid, 2-methyl-3-isopropyl acrylic acid, trans-2-octenoic acid, cis-2-octenoic acid, trans-2-decenoic acid, α-acetoxyacrylic acid, (β-trans-aryloxyacrylic acid, α-chloro-β-E-methoxyacrylic acid, or combinations thereof. In some embodiments, the carboxylic acid is methyl maleic acid, dimethyl maleic acid, phenyl maleic acid, bromo maleic acid, chloromaleic acid, dichloromaleic acid, fluoromaleic acid, difluoro maleic acid, nonyl hydrogen maleate, decyl hydrogen maleate, dodecyl hydrogen maleate, octadecyl hydrogen maleate, fluoroalkyl hydrogen maleate, or combinations thereof. In some embodiments, the carboxylic acid is maleic anhydride, methyl maleic anhydride, dimethyl maleic anhydride, acrylic anhydride, methacrylic anhydride, methacrolein, methacryloyl chloride, methacryloyl fluoride, methacryloyl bromide, or combinations thereof.

In some embodiments, the sulfonic acid is vinylsulfonic acid, methylvinylsulfonic acid, allylvinylsulfonic acid, allylsulfonic acid, methallylsulfonic acid, styrenesulfonic acid, 2-sulfoethyl methacrylic acid, 2-methylprop-2-ene-1-sulfonic acid, 2-acrylamido-2-methyl-1-propane sulfonic acid, 3-allyloxy-2-hydroxy-1-propane sulfonic acid, or combinations thereof.

In some embodiments, the sulfuric acid is allyl hydrogen sulfate, vinyl hydrogensulfate, 4-allyl phenol sulphate, or combinations thereof.

In some embodiments, the phosphonic acid is vinyl phosphonic acid, allyl phosphonic acid, vinyl benzyl phosphonic acid, acrylamide alkyl phosphonic acid, methacrylamide alkyl phosphonic acid, acrylamide alkyl diphosphonic acid, acryloylphosphonic acid, 2-methacryloyloxyethyl phosphonic acid, bis(2-methacryloyloxyethyl) phosphonic acid, ethylene 2-methacryloyloxyethyl phosphonic acid, ethyl-methacryloyloxyethyl phosphonic acid, or combinations thereof.

In some embodiments, the phosphoric acid is mono (2-acryloyloxyethyl) phosphate, mono (2-methacryloyloxyethyl) phosphate, diphenyl (2-acryloyloxyethyl) phosphate, diphenyl (2-methacryloyloxyethyl) phosphate, phenyl (2-acryloyloxyethyl) phosphate, phosphoxyethyl methacrylate, 3-chloro-2-phosphoryloxy propyl methacrylate, phosphoryloxy poly(ethylene glycol) monomethacrylate, phosphoryloxy poly(propylene glycol) methacrylate, (meth)acryloyloxyethyl phosphate, (meth)acryloyloxypropyl phosphate, (meth)acryloyloxy-2-hydroxypropyl phosphate, (meth)acryloyloxy-3-hydroxypropyl phosphate, (meth)acryloyloxy-3-chloro-2 hydroxypropyl phosphate, allyl hydrogen phosphate, vinyl hydrogen phosphate, allyl hydrogen pyrophosphate, vinyl hydrogen pyrophosphate, allyl hydrogen tripolyphosphate, vinyl hydrogen tripolyphosphate, allyl hydrogen tetrapolyphosphate, vinyl hydrogen tetrapolyphosphate, allyl hydrogen trimetaphosphate, vinyl hydrogen trimetaphosphate, isopentenyl phosphate, isopentenyl pyrophosphate, or combinations thereof, wherein (meth)acryloyl- represents acryloyl- or methacryloyl-.

In some embodiments, the nitric acid is allyl hydrogen nitrate, ethenyl hydrogen nitrate, or combinations thereof.

In some embodiments, the proportion of structural unit (a) within the water-compatible copolymer is from about 5% to about 95%, from about 5% to about 90%, from about 5% to about 85%, from about 5% to about 80%, from about 5% to about 75%, from about 5% to about 70%, from about 5% to about 65%, from about 5% to about 60%, from about 5% to about 55%, from about 5% to about 50%, from about 5% to about 45%, from about 5% to about 40%, from about 5% to about 35%, from about 5% to about 30%, from about 5% to about 25%, from about 10% to about 95%, from about 10% to about 90%, from about 10% to about 85%, from about 10% to about 80%, from about 10% to about 75%, from about 10% to about 70%, from about 10% to about 65%, from about 10% to about 60%, from about 10% to about 55%, from about 10% to about 50%, from about 10% to about 45%, from about 10% to about 40%, from about 10% to about 35%, from about 10% to about 30%, from about 15% to about 95%, from about 15% to about 90%, from about 15% to about 85%, from about 15% to about 80%, from about 15% to about 75%, from about 15% to about 70%, from about 15% to about 65%, from about 15% to about 60%, from about 15% to about 55%, from about 15% to about 50%, from about 15% to about 45%, from about 15% to about 40%, from about 15% to about 35%, from about 20% to about 95%, from about 20% to about 90%, from about 20% to about 85%, from about 20% to about 80%, from about 20% to about 75%, from about 20% to about 70%, from about 20% to about 65%, from about 20% to about 60%, from about 20% to about 55%, from about 20% to about 50%, from about 20% to about 45%, from about 20% to about 40%, from about 25% to about 95%, from about 25% to about 90%, from about 25% to about 85%, from about 25% to about 80%, from about 25% to about 75%, from about 25% to about 70%, from about 25% to about 65%, from about 25% to about 60%, from about 25% to about 55%, from about 25% to about 50%, from about 25% to about 45%, from about 30% to about 95%, from about 30% to about 90%, from about 30% to about 85%, from about 30% to about 80%, from about 30% to about 75%, from about 30% to about 70%, from about 30% to about 65%, from about 30% to about 60%, from about 30% to about 55%, from about 30% to about 50%, from about 35% to about 95%, from about 35% to about 90%, from about 35% to about 85%, from about 35% to about 80%, from about 35% to about 75%, from about 35% to about 70%, from about 35% to about 65%, from about 35% to about 60%, from about 35% to about 55%, from about 40% to about 95%, from about 40% to about 90%, from about 40% to about 85%, from about 40% to about 80%, from about 40% to about 75%, from about 40% to about 70%, from about 40% to about 65%, from about 40% to about 60%, from about 45% to about 95%, from about 45% to about 90%, from about 45% to about 85%, from about 45% to about 80%, from about 45% to about 75%, from about 45% to about 70%, from about 45% to about 65%, from about 50% to about 95%, from about 50% to about 90%, from about 50% to about 85%, from about 50% to about 80%, from about 50% to about 75%, from about 50% to about 70%, from about 55% to about 95%, from about 55% to about 90%, from about 55% to about 85%, from about 55% to about 80%, from about 55% to about 75%, from about 60% to about 95%, from about 60% to about 90%, from about 60% to about 85%, from about 60% to about 80%, from about 65% to about 95%, from about 65% to about 90%, from about 65% to about 85%, from about 70% to about 95%, from about 70% to about 90%, from about 75% to about 95%, from about 75% to about 90%, from about 80% to about 95%, or from about 80% to about 90% by mole, based on the total number of moles of monomeric units in the copolymer.

In some embodiments, the proportion of structural unit (a) within the water-compatible copolymer is about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, or about 95% by mole, based on the total number of moles of monomeric units in the copolymer.

In some embodiments, the proportion of structural unit (a) within the water-compatible copolymer is less than 95%, less than 90%, less than 85%, less than 80%, less than 75%, less than 70%, less than 65%, less than 60%, less than 55%, less than 50%, less than 45%, less than 40%, less than 35%, less than 30%, less than 25%, less than 20%, or less than 15% by mole, based on the total number of moles of monomeric units in the copolymer. In some embodiments, the proportion of structural unit (a) within the water-compatible copolymer is more than 5%, more than 10%, more than 15%, more than 20%, more than 25%, more than 30%, more than 35%, more than 40%, more than 45%, more than 50%, more than 55%, more than 60%, more than 65%, more than 70%, more than 75%, more than 80%, or more than 85% by mole, based on the total number of moles of monomeric units in the copolymer.

In some embodiments, the water-compatible copolymer further comprises a structural unit (b) that is derived from a monomer selected from the group consisting of an amide group-containing monomer, a hydroxyl group-containing monomer, and combinations thereof.

In some embodiments, the amide group-containing monomer is acrylamide, methacrylamide, N-methyl methacrylamide, N-ethyl methacrylamide, N-n-propyl methacrylamide, N-isopropyl methacrylamide, isopropyl acrylamide, N-n-butyl methacrylamide, N-isobutyl methacrylamide, N,N-dimethyl acrylamide, N,N-dimethyl methacrylamide, N,N-diethyl acrylamide, N,N-diethyl methacrylamide, N-methylol methacrylamide, N-(methoxymethyl)methacrylamide, N-(ethoxymethyl)methacrylamide, N-(propoxymethyl)methacrylamide, N-(butoxymethyl)methacrylamide, N,N-dimethylaminopropyl methacrylamide, N,N-dimethylaminoethyl methacrylamide, N,N-dimethylol methacrylamide, diacetone methacrylamide, diacetone acrylamide, methacryloyl morpholine, N-hydroxyl methacrylamide, N-methoxymethyl acrylamide, N-methoxymethyl methacrylamide, N,N′-methylene-bis-acrylamide (MBA), N-hydroxymethyl acrylamide, or combinations thereof.

In some embodiments, the hydroxyl group-containing monomer is an acrylate or methacrylate containing a C₁-C₂₀ alkyl or C₅-C₂₀ cycloalkyl with a hydroxyl group. In some embodiments, the hydroxyl group-containing monomer is 2-hydroxyethylacrylate, 2-hydroxyethyl methacrylate, 2-hydroxypropyl acrylate, 2-hydroxypropyl methacrylate, 2-hydroxybutyl methacrylate, 3-hydroxypropylacrylate, 3-hydroxypropylmethacrylate, 4-hydroxybutyl methacrylate, 5-hydroxypentylacrylate, 6-hydroxyhexyl methacrylate, 1,4-cyclohexanedimethanol mono(meth)acrylate, 3-chloro-2-hydroxypropyl methacrylate, diethylene glycol mono(meth)acrylate, allyl alcohol, or combinations thereof.

In some embodiments, the proportion of structural unit (b) within the water-compatible copolymer is from about 5% to about 95%, from about 5% to about 90%, from about 5% to about 85%, from about 5% to about 80%, from about 5% to about 75%, from about 5% to about 70%, from about 5% to about 65%, from about 5% to about 60%, from about 5% to about 55%, from about 5% to about 50%, from about 5% to about 45%, from about 5% to about 40%, from about 5% to about 35%, from about 5% to about 30%, from about 5% to about 25%, from about 10% to about 95%, from about 10% to about 90%, from about 10% to about 85%, from about 10% to about 80%, from about 10% to about 75%, from about 10% to about 70%, from about 10% to about 65%, from about 10% to about 60%, from about 10% to about 55%, from about 10% to about 50%, from about 10% to about 45%, from about 10% to about 40%, from about 10% to about 35%, from about 10% to about 30%, from about 15% to about 95%, from about 15% to about 90%, from about 15% to about 85%, from about 15% to about 80%, from about 15% to about 75%, from about 15% to about 70%, from about 15% to about 65%, from about 15% to about 60%, from about 15% to about 55%, from about 15% to about 50%, from about 15% to about 45%, from about 15% to about 40%, from about 15% to about 35%, from about 20% to about 95%, from about 20% to about 90%, from about 20% to about 85%, from about 20% to about 80%, from about 20% to about 75%, from about 20% to about 70%, from about 20% to about 65%, from about 20% to about 60%, from about 20% to about 55%, from about 20% to about 50%, from about 20% to about 45%, from about 20% to about 40%, from about 25% to about 95%, from about 25% to about 90%, from about 25% to about 85%, from about 25% to about 80%, from about 25% to about 75%, from about 25% to about 70%, from about 25% to about 65%, from about 25% to about 60%, from about 25% to about 55%, from about 25% to about 50%, from about 25% to about 45%, from about 30% to about 95%, from about 30% to about 90%, from about 30% to about 85%, from about 30% to about 80%, from about 30% to about 75%, from about 30% to about 70%, from about 30% to about 65%, from about 30% to about 60%, from about 30% to about 55%, from about 30% to about 50%, from about 35% to about 95%, from about 35% to about 90%, from about 35% to about 85%, from about 35% to about 80%, from about 35% to about 75%, from about 35% to about 70%, from about 35% to about 65%, from about 35% to about 60%, from about 35% to about 55%, from about 40% to about 95%, from about 40% to about 90%, from about 40% to about 85%, from about 40% to about 80%, from about 40% to about 75%, from about 40% to about 70%, from about 40% to about 65%, from about 40% to about 60%, from about 45% to about 95%, from about 45% to about 90%, from about 45% to about 85%, from about 45% to about 80%, from about 45% to about 75%, from about 45% to about 70%, from about 45% to about 65%, from about 50% to about 95%, from about 50% to about 90%, from about 50% to about 85%, from about 50% to about 80%, from about 50% to about 75%, from about 50% to about 70%, from about 55% to about 95%, from about 55% to about 90%, from about 55% to about 85%, from about 55% to about 80%, from about 55% to about 75%, from about 60% to about 95%, from about 60% to about 90%, from about 60% to about 85%, from about 60% to about 80%, from about 65% to about 95%, from about 65% to about 90%, from about 65% to about 85%, from about 70% to about 95%, from about 70% to about 90%, from about 75% to about 95%, from about 75% to about 90%, from about 80% to about 95%, or from about 80% to about 90% by mole, based on the total number of moles of monomeric units in the copolymer.

In some embodiments, the proportion of structural unit (b) within the water-compatible copolymer is about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, or about 95% by mole, based on the total number of moles of monomeric units in the copolymer.

In some embodiments, the proportion of structural unit (b) within the water-compatible copolymer is less than 95%, less than 90%, less than 85%, less than 80%, less than 75%, less than 70%, less than 65%, less than 60%, less than 55%, less than 50%, less than 45%, less than 40%, less than 35%, less than 30%, less than 25%, less than 20%, or less than 15% by mole, based on the total number of moles of monomeric units in the copolymer. In some embodiments, the proportion of structural unit (b) within the water-compatible copolymer is more than 5%, more than 10%, more than 15%, more than 20%, more than 25%, more than 30%, more than 35%, more than 40%, more than 45%, more than 50%, more than 55%, more than 60%, more than 65%, more than 70%, more than 75%, more than 80%, or more than 85% by mole, based on the total number of moles of monomeric units in the copolymer.

In some embodiments, the water-compatible copolymer further comprises a structural unit (c) that is derived from a monomer selected from the group consisting of a nitrile group-containing monomer, an ester group-containing monomer, an ether group-containing monomer, an epoxy group-containing monomer, a carbonyl group-containing monomer, a fluorine-containing monomer, and combinations thereof.

In some embodiments, the nitrile group-containing monomer includes a,β-ethylenically unsaturated nitrile monomers. In some embodiments, the nitrile group-containing monomer is acrylonitrile, α-halogenoacrylonitrile, α-alkylacrylonitrile, or combinations thereof. In some embodiments, the nitrile group-containing monomer is α-chloroacrylonitrile, α-bromoacrylonitrile, α-fluoroacrylonitrile, methacrylonitrile, α-ethylacrylonitrile, α-isopropylacrylonitrile, α-n-hexylacrylonitrile, α-methoxyacrylonitrile, 3-methoxyacrylonitrile, 3-ethoxyacrylonitrile, α-acetoxyacrylonitrile, α-phenylacrylonitrile, α-tolylacrylonitrile, α-(methoxyphenyl)acrylonitrile, α-(chlorophenyl)acrylonitrile, α-(cyanophenyl)acrylonitrile, vinylidene cyanide, or combinations thereof.

In some embodiments, the ester group-containing monomer is C₁-C₂₀ alkyl acrylate, C₁-C₂₀ alkyl methacrylate, cycloalkyl acrylate, or combinations thereof. In some embodiments, the ester group-containing monomer is methyl acrylate, ethyl acrylate, n-propyl acrylate, isopropyl acrylate, n-butyl acrylate, sec-butyl acrylate, tert-butyl acrylate, pentyl acrylate, hexyl acrylate, heptyl acrylate, octyl acrylate, 3,3,5-trimethylhexyl acrylate, 2-ethylhexyl acrylate, nonyl acrylate, decyl acrylate, lauryl acrylate, n-tetradecyl acrylate, octadecyl acrylate, cyclohexyl acrylate, phenyl acrylate, methoxymethyl acrylate, methoxyethyl acrylate, ethoxymethyl acrylate, ethoxyethyl acrylate, perfluorooctyl acrylate, stearyl acrylate, or combinations thereof. In some embodiments, the ester group-containing monomer is cyclohexyl acrylate, cyclohexyl methacrylate, isobornyl acrylate, isobornyl methacrylate, 3,3,5-trimethylcyclohexylacrylate, or combinations thereof. In some embodiments, the ester group-containing monomer is methyl methacrylate, ethyl methacrylate, n-propyl methacrylate, isopropyl methacrylate, n-butyl methacrylate, sec-butyl methacrylate, tert-butyl methacrylate, isobutyl methacrylate, n-pentyl methacrylate, isopentyl methacrylate, hexyl methacrylate, heptyl methacrylate, octyl methacrylate, 2-ethylhexyl methacrylate, nonyl methacrylate, decyl methacrylate, lauryl methacrylate, n-tetradecyl methacrylate, stearyl methacrylate, 2,2,2-trifluoroethyl methacrylate, phenyl methacrylate, benzyl methacrylate, or combinations thereof.

In some embodiments, the ether group-containing monomer is vinyl ether, allyl ether, allyl vinyl ether, allyl glycidyl ether, 2H-hexafluoro isopropyl allyl ether, hydroxypolyethoxy (10) allyl ether, allyl phenethyl ether, ethyl vinyl ether, propyl vinyl ether, n-butyl vinyl ether, or combinations thereof.

In some embodiments, the epoxy group-containing monomer is vinyl glycidyl ether, allyl glycidyl ether, allyl 2,3-epoxypropyl ether, butenyl glycidyl ether, butadiene monoepoxide, chloroprene monoepoxide, 3,4-epoxy-1-butene, 4,5-epoxy-2-pentene, 3,4-epoxy-1-vinylcyclohexane, 1,2-epoxy-4-vinylcyclohexane, 3,4-epoxy cyclohexylethylene, epoxy-4-vinylcyclohexene, 1,2-epoxy-5,9-cyclododecadiene, or combinations thereof. In some embodiments, the epoxy group-containing monomer is 1,2-epoxy-5-hexene, 1,2-epoxy-9-decene, glycidyl acrylate, glycidyl methacrylate, glycidyl crotonate, glycidyl 2,4-dimethyl pentenoate, glycidyl 4-hexenoate, glycidyl 4-heptenoate, glycidyl 5-methyl-4-heptenoate, glycidyl sorbate, glycidyl linoleate, glycidyl oleate, glycidyl 3-butenoate, glycidyl 3-pentenoate, glycidyl-4-methyl-3-pentenoate, or combinations thereof.

In some embodiments, the carbonyl group-containing monomer is methyl vinyl ketone, ethyl vinyl ketone, acrolein, acryloyl chloride, cinnamaldehyde, E-crotonaldehyde, 2-hexenal, oct-2-enal, 2-methylpent-2-enal, 4-methylpent-3-en-2-one, oct-1-en-3-one, 2-pentylbut-1-en-3-one, or combinations thereof.

In some embodiments, the fluorine-containing monomer is an acrylate or methacrylate containing a C₁-C₂₀ alkyl group or combinations thereof, wherein the monomer comprises at least one fluorine atom. In some embodiments, the fluorine-containing monomer is perfluoro alkyl acrylate such as perfluoro dodecyl acrylate, perfluoro n-octyl acrylate, perfluoro n-butyl acrylate, perfluoro hexylethyl acrylate and perfluoro octylethyl acrylate; perfluoro alkyl methacrylate such as perfluoro dodecyl methacrylate, perfluoro n-octyl methacrylate, perfluoro n-butyl methacrylate, perfluoro hexylethyl methacrylate and perfluoro octylethyl methacrylate; perfluoro oxyalkyl acrylate such as perfluoro dodecyloxyethyl acrylate and perfluoro decyloxyethyl acrylate; perfluoro oxyalkyl methacrylate such as perfluoro dodecyloxyethyl methacrylate and perfluoro decyloxyethyl methacrylate, or combinations thereof. In some embodiments, the fluorine-containing monomer is a carboxylate containing a C₁-C₂₀ alkyl group and a fluorine atom; wherein the carboxylate is selected from the group consisting of crotonate, malate, fumarate, itaconate, or combinations thereof. In some embodiments, the fluorine-containing monomer is vinyl fluoride, trifluoroethylene, trifluorochloroethylene, fluoroalkyl vinyl ether, perfluoroalkyl vinyl ether, hexafluoropropylene, 2,3,3,3-tetrafluoropropene, vinylidene fluoride, tetrafluoroethylene, 2-fluoro acrylate, or combinations thereof.

In some embodiments, the proportion of structural unit (c) within the water-compatible copolymer is from about 5% to about 95%, from about 5% to about 90%, from about 5% to about 85%, from about 5% to about 80%, from about 5% to about 75%, from about 5% to about 70%, from about 5% to about 65%, from about 5% to about 60%, from about 5% to about 55%, from about 5% to about 50%, from about 5% to about 45%, from about 5% to about 40%, from about 5% to about 35%, from about 5% to about 30%, from about 5% to about 25%, from about 10% to about 95%, from about 10% to about 90%, from about 10% to about 85%, from about 10% to about 80%, from about 10% to about 75%, from about 10% to about 70%, from about 10% to about 65%, from about 10% to about 60%, from about 10% to about 55%, from about 10% to about 50%, from about 10% to about 45%, from about 10% to about 40%, from about 10% to about 35%, from about 10% to about 30%, from about 15% to about 95%, from about 15% to about 90%, from about 15% to about 85%, from about 15% to about 80%, from about 15% to about 75%, from about 15% to about 70%, from about 15% to about 65%, from about 15% to about 60%, from about 15% to about 55%, from about 15% to about 50%, from about 15% to about 45%, from about 15% to about 40%, from about 15% to about 35%, from about 20% to about 95%, from about 20% to about 90%, from about 20% to about 85%, from about 20% to about 80%, from about 20% to about 75%, from about 20% to about 70%, from about 20% to about 65%, from about 20% to about 60%, from about 20% to about 55%, from about 20% to about 50%, from about 20% to about 45%, from about 20% to about 40%, from about 25% to about 95%, from about 25% to about 90%, from about 25% to about 85%, from about 25% to about 80%, from about 25% to about 75%, from about 25% to about 70%, from about 25% to about 65%, from about 25% to about 60%, from about 25% to about 55%, from about 25% to about 50%, from about 25% to about 45%, from about 30% to about 95%, from about 30% to about 90%, from about 30% to about 85%, from about 30% to about 80%, from about 30% to about 75%, from about 30% to about 70%, from about 30% to about 65%, from about 30% to about 60%, from about 30% to about 55%, from about 30% to about 50%, from about 35% to about 95%, from about 35% to about 90%, from about 35% to about 85%, from about 35% to about 80%, from about 35% to about 75%, from about 35% to about 70%, from about 35% to about 65%, from about 35% to about 60%, from about 35% to about 55%, from about 40% to about 95%, from about 40% to about 90%, from about 40% to about 85%, from about 40% to about 80%, from about 40% to about 75%, from about 40% to about 70%, from about 40% to about 65%, from about 40% to about 60%, from about 45% to about 95%, from about 45% to about 90%, from about 45% to about 85%, from about 45% to about 80%, from about 45% to about 75%, from about 45% to about 70%, from about 45% to about 65%, from about 50% to about 95%, from about 50% to about 90%, from about 50% to about 85%, from about 50% to about 80%, from about 50% to about 75%, from about 50% to about 70%, from about 55% to about 95%, from about 55% to about 90%, from about 55% to about 85%, from about 55% to about 80%, from about 55% to about 75%, from about 60% to about 95%, from about 60% to about 90%, from about 60% to about 85%, from about 60% to about 80%,from about 65% to about 95%, from about 65% to about 90%, from about 65% to about 85%, from about 70% to about 95%, from about 70% to about 90%, from about 75% to about 95%, from about 75% to about 90%, from about 80% to about 95%, or from about 80% to about 90% by mole, based on the total number of moles of monomeric units in the copolymer.

In some embodiments, the proportion of structural unit (c) within the water-compatible copolymer is about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, or about 95% by mole, based on the total number of moles of monomeric units in the copolymer.

In some embodiments, the proportion of structural unit (c) within the water-compatible copolymer is less than 95%, less than 90%, less than 85%, less than 80%, less than 75%, less than 70%, less than 65%, less than 60%, less than 55%, less than 50%, less than 45%, less than 40%, less than 35%, less than 30%, less than 25%, less than 20%, or less than 15% by mole, based on the total number of moles of monomeric units in the copolymer. In some embodiments, the proportion of structural unit (c) within the water-compatible copolymer is more than 5%, more than 10%, more than 15%, more than 20%, more than 25%, more than 30%, more than 35%, more than 40%, more than 45%, more than 50%, more than 55%, more than 60%, more than 65%, more than 70%, more than 75%, more than 80%, or more than 85% by mole, based on the total number of moles of monomeric units in the copolymer.

In other embodiments, the water-compatible copolymer may additionally comprise a structural unit derived from an olefin. Any hydrocarbon that has at least one carbon-carbon double bond may be used as the olefin. In some embodiments, the olefin includes a C₂-C₂₀ aliphatic compound, a C₈-C₂₀ aromatic or cyclic compound containing vinylic unsaturation, a C₄-C₄₀ diene, and combinations thereof. In some embodiments, the olefin is styrene, ethylene, propylene, isobutylene, 1-butene, 1-pentene, 1-hexene, 1-heptene, 1-octene, 1-nonene, 1-decene, 1-dodecene, 1-tetradecene, 1-hexadecene, 1-octadecene, 1-eicosene, 3-methyl-1-butene, cyclobutene, 3-methyl-1-pentene, 4-methyl-1-pentene, 4,6-dimethyl-1-heptene, 4-vinylcyclohexene, vinyl cyclohexane, norbornene, norbornadiene, ethylidene norbornene, cyclopentene, cyclohexene, dicyclopentadiene, cyclooctene, or combinations thereof. In some embodiments, the water-compatible copolymer does not comprise a structural unit derived from an olefin. In some embodiments, the water-compatible copolymer does not comprise a structural unit derived from styrene, ethylene, propylene, isobutylene, 1-butene, 1-pentene, 1-hexene, 1-heptene, 1-octene, 1-nonene, 1-decene, 1-dodecene, 1-tetradecene, 1-hexadecene, 1-octadecene, 1-eicosene, 3-methyl-1-butene, cyclobutene, 3-methyl-1-pentene, 4-methyl-1-pentene, 4,6-dimethyl-1-heptene, 4-vinylcyclohexene, vinyl cyclohexane, norbornene, norbornadiene, ethylidene norbornene, cyclopentene, cyclohexene, dicyclopentadiene or cyclooctene.

A conjugated diene constitutes an olefin. In some embodiments, the conjugated diene is selected from the group consisting of C₄-C₄₀ dienes; aliphatic conjugated dienes such as 1,3-butadiene, 1,3-pentadiene, 1,4-hexadiene, 1,5-hexadiene, 1,7-octadiene, 1,9-decadiene, isoprene, myrcene, 2-methyl-1,3-butadiene, 2,3-dimethyl-1,3-butadiene, 2-chloro-1,3-butadiene; substituted linear conjugated pentadienes; substituted branched conjugated hexadienes; and combinations thereof. In some embodiments, the water-compatible copolymer does not comprise a structural unit derived from C₄-C₄₀ dienes; aliphatic conjugated dienes (in particular, 1,3-butadiene, 1,3-pentadiene, 1,4-hexadiene, 1,5-hexadiene, 1,7-octadiene, 1,9-decadiene, isoprene, myrcene, 2-methyl-1,3-butadiene, 2,3-dimethyl-1,3-butadiene, or 2-chloro-1,3-butadiene); substituted linear conjugated pentadienes; or substituted branched conjugated hexadienes.

In other embodiments, the water-compatible copolymer may additionally comprise a structural unit derived from an aromatic vinyl group-containing monomer. In some embodiments, the aromatic vinyl group-containing monomer is styrene, α-methylstyrene, vinyltoluene, divinylbenzene, or combinations thereof. In some embodiments, the copolymer does not comprise a structural unit derived from an aromatic vinyl group-containing monomer. In some embodiments, the copolymer does not comprise a structural unit derived from styrene, α-methylstyrene, vinyltoluene or divinylbenzene.

Copolymers with the above structural unit proportions have excellent binder performance. Furthermore, such copolymers are water-compatible and dispersed well in aqueous solvents, making them easy to process when used in a water-based electrode slurry. Moreover, batteries comprising electrodes with the water-compatible copolymer disclosed herein have superb capacity and electrochemical performance.

After the polymerization process, a post-reaction mixture is formed. This post-reaction mixture mainly comprises the aqueous medium used in the polymerization process and a solid portion. In some embodiments, the solid portion of the post-reaction mixture comprises the water-compatible copolymer.

In some embodiments, the solid content of the post-reaction mixture is from about 1% to about 20%, from about 2% to about 20%, from about 3% to about 20%, from about 4% to about 20%, from about 5% to about 20%, from about 6% to about 20%, from about 7% to about 20%, from about 8% to about 20%, from about 9% to about 20%, from about 10% to about 20%, from about 1% to about 18%, from about 2% to about 18%, from about 3% to about 18%, from about 4% to about 18%, from about 5% to about 18%, from about 6% to about 18%, from about 7% to about 18%, from about 8% to about 18%, from about 9% to about 18%, from about 10% to about 18%, from about 1% to about 15%, from about 2% to about 15%, from about 3% to about 15%, from about 4% to about 15%, from about 5% to about 15%, from about 6% to about 15%, from about 7% to about 15%, from about 8% to about 15%, from about 1% to about 12%, from about 2% to about 12%, from about 3% to about 12%, from about 4% to about 12%, from about 5% to about 12%, from about 1% to about 10%, from about 2% to about 10%, from about 3% to about 10%, from about 4% to about 10%, or from about 5% to about 10% by weight, based on the total weight of the post-reaction mixture.

In some embodiments, the solid content of the post-reaction mixture is less than 20%, less than 19%, less than 18%, less than 17%, less than 16%, less than 15%, less than 14%, less than 13%, less than 12%, less than 11%, less than 10%, less than 9%, less than 8%, less than 7%, less than 6%, or less than 5% by weight, based on the total weight of the post-reaction mixture. In some embodiments, the solid content of the post-reaction mixture is more than 1%, more than 2%, more than 3%, more than 4%, more than 5%, more than 6%, more than 7%, more than 8%, more than 9%, more than 10%, more than 11%, more than 12%, more than 13%, more than 14%, or more than 15% by weight, based on the total weight of the post-reaction mixture.

When the weight-average molecular weight of the water-compatible copolymer is within the ranges set forth below, electrode layers comprising the copolymer has good adhesive strength and batteries comprising such electrode layers display good cycle characteristics.

In some embodiments, the weight-average molecular weight of the water-compatible copolymer is from about 10,000 g/mol to about 1,000,000 g/mol, from about 10,000 g/mol to about 800,000 g/mol, from about 10,000 g/mol to about 500,000 g/mol, from about 10,000 g/mol to about 400,000 g/mol, from about 10,000 g/mol to about 300,000 g/mol, from about 10,000 g/mol to about 200,000 g/mol, from about 10,000 g/mol to about 180,000 g/mol from about 10,000 g/mol to about 150,000 g/mol, from about 10,000 g/mol to about 120,000 g/mol, from about 10,000 g/mol to about 100,000 g/mol, from about 10,000 g/mol to about 80,000 g/mol, from about 10,000 g/mol to about 50,000 g/mol, from about 50,000 g/mol to about 1,000,000 g/mol, from about 50,000 g/mol to about 800,000 g/mol, from about 50,000 g/mol to about 500,000 g/mol, from about 50,000 g/mol to about 400,000 g/mol, from about 50,000 g/mol to about 300,000 g/mol, from about 50,000 g/mol to about 200,000 g/mol, from about 50,000 g/mol to about 180,000 g/mol, from about 50,000 g/mol to about 150,000 g/mol, from about 100,000 g/mol to about 1,000,000 g/mol, from about 100,000 g/mol to about 800,000 g/mol, from about 100,000 g/mol to about 500,000 g/mol, from about 100,000 g/mol to about 400,000 g/mol, from about 100,000 g/mol to about 300,000 g/mol, from about 100,000 g/mol to about 200,000 g/mol, from about 100,000 g/mol to about 180,000 g/mol, from about 100,000 g/mol to about 150,000 g/mol, from about 120,000 g/mol to about 1,000,000 g/mol, from about 120,000 g/mol to about 800,000 g/mol, from about 120,000 g/mol to about 600,000 g/mol, from about 120,000 g/mol to about 500,000 g/mol, from about 120,000 g/mol to about 400,000 g/mol, from about 120,000 g/mol to about 300,000 g/mol, from about 120,000 g/mol to about 200,000 g/mol, from about 120,000 g/mol to about 190,000 g/mol, from about 120,000 g/mol to about 180,000 g/mol, from about 140,000 g/mol to about 1,000,000 g/mol, from about 140,000 g/mol to about 800,000 g/mol, from about 140,000 g/mol to about 500,000 g/mol, from about 140,000 g/mol to about 400,000 g/mol, from about 140,000 g/mol to about 300,000 g/mol, from about 140,000 g/mol to about 200,000 g/mol, from about 140,000 g/mol to about 190,000 g/mol, from about 140,000 g/mol to about 180,000 g/mol, from about 150,000 g/mol to about 1,000,000 g/mol, from about 150,000 g/mol to about 800,000 g/mol, from about 150,000 g/mol to about 500,000 g/mol, from about 150,000 g/mol to about 400,000 g/mol, from about 150,000 g/mol to about 300,000 g/mol, from about 150,000 g/mol to about 200,000 g/mol, from about 150,000 g/mol to about 190,000 g/mol, from about 150,000 g/mol to about 180,000 g/mol, from about 200,000 g/mol to about 1,000,000 g/mol, from about 200,000 g/mol to about 800,000 g/mol, from about 200,000 g/mol to about 600,000 g/mol, from about 200,000 g/mol to about 500,000 g/mol, from about 200,000 g/mol to about 400,000 g/mol, from about 500,000 g/mol to about 1,000,000 g/mol, from about 500,000 g/mol to about 900,000 g/mol, or from about 500,000 g/mol to about 800,000 g/mol.

In some embodiments, the weight-average molecular weight of the water-compatible copolymer is less than 1,000,000 g/mol, less than 800,000 g/mol, less than 600,000 g/mol, less than 500,000 g/mol, less than 400,000 g/mol, less than 300,000 g/mol, less than 200,000 g/mol, less than 190,000 g/mol, less than 180,000 g/mol, less than 170,000 g/mol, less than 160,000 g/mol, less than 150,000 g/mol, less than 140,000 g/mol, less than 130,000 g/mol, less than 120,000 g/mol, less than 110,000 g/mol, less than 100,000 g/mol, less than 90,000 g/mol, less than 80,000 g/mol, less than 70,000 g/mol, less than 60,000 g/mol, or less than 50,000 g/mol. In some embodiments, the weight-average molecular weight of the water-compatible copolymer is more than 10,000 g/mol, more than 20,000 g/mol, more than 30,000 g/mol, more than 40,000 g/mol, more than 50,000 g/mol, more than 60,000 g/mol, more than 70,000 g/mol, more than 80,000 g/mol, more than 90,000 g/mol, more than 100,000 g/mol, more than 110,000 g/mol, more than 120,000 g/mol, more than 130,000 g/mol, more than 140,000 g/mol, more than 150,000 g/mol, more than 160,000 g/mol, more than 170,000 g/mol, more than 180,000 g/mol, more than 190,000 g/mol, more than 200,000 g/mol, more than 300,000 g/mol, more than 400,000 g/mol, more than 500,000 g/mol, more than 600,000 g/mol, or more than 700,000 g/mol.

In some embodiments, the number-average molecular weight of the water-compatible copolymer is from about 10,000 g/mol to about 500,000 g/mol, from about 10,000 g/mol to about 300,000 g/mol, from about 10,000 g/mol to about 200,000 g/mol, from about 10,000 g/mol to about 100,000 g/mol, from about 10,000 g/mol to about 90,000 g/mol, from about 10,000 g/mol to about 80,000 g/mol, from about 10,000 g/mol to about 70,000 g/mol, from about 10,000 g/mol to about 60,000 g/mol, from about 10,000 g/mol to about 50,000 g/mol, from about 10,000 g/mol to about 40,000 g/mol, from about 20,000 g/mol to about 500,000 g/mol, from about 20,000 g/mol to about 300,000 g/mol, from about 20,000 g/mol to about 200,000 g/mol, from about 20,000 g/mol to about 100,000 g/mol, from about 20,000 g/mol to about 90,000 g/mol, from about 20,000 g/mol to about 80,000 g/mol, from about 20,000 g/mol to about 70,000 g/mol, from about 20,000 g/mol to about 60,000 g/mol, from about 20,000 g/mol to about 50,000 g/mol, from about 30,000 g/mol to about 500,000 g/mol, from about 30,000 g/mol to about 300,000 g/mol, from about 30,000 g/mol to about 200,000 g/mol, from about 30,000 g/mol to about 100,000 g/mol, from about 30,000 g/mol to about 90,000 g/mol, from about 30,000 g/mol to about 80,000 g/mol, from about 30,000 g/mol to about 70,000 g/mol, from about 40,000 g/mol to about 500,000 g/mol, from about 40,000 g/mol to about 300,000 g/mol, from about 40,000 g/mol to about 200,000 g/mol, from about 40,000 g/mol to about 100,000 g/mol, from about 40,000 g/mol to about 90,000 g/mol, from about 40,000 g/mol to about 80,000 g/mol, from about 40,000 g/mol to about 70,000 g/mol, from about 50,000 g/mol to about 500,000 g/mol, from about 50,000 g/mol to about 300,000 g/mol, from about 50,000 g/mol to about 200,000 g/mol, from about 50,000 g/mol to about 100,000 g/mol, from about 50,000 g/mol to about 90,000 g/mol, from about 50,000 g/mol to about 80,000 g/mol, from about 60,000 g/mol to about 500,000 g/mol, from about 60,000 g/mol to about 300,000 g/mol, from about 60,000 g/mol to about 200,000 g/mol, from about 60,000 g/mol to about 150,000 g/mol, from about 60,000 g/mol to about 100,000 g/mol, from about 60,000 g/mol to about 90,000 g/mol, from about 70,000 g/mol to about 500,000 g/mol, from about 70,000 g/mol to about 300,000 g/mol, from about 70,000 g/mol to about 200,000 g/mol, from about 70,000 g/mol to about 150,000 g/mol, from about 70,000 g/mol to about 100,000 g/mol, from about 80,000 g/mol to about 500,000 g/mol, from about 80,000 g/mol to about 300,000 g/mol, from about 80,000 g/mol to about 200,000 g/mol, from about 80,000 g/mol to about 150,000 g/mol, from about 90,000 g/mol to about 500,000 g/mol, from about 90,000 g/mol to about 300,000 g/mol, from about 90,000 g/mol to about 200,000 g/mol, from about 90,000 g/mol to about 150,000 g/mol, from about 100,000 g/mol to about 500,000 g/mol, from about 100,000 g/mol to about 300,000 g/mol, or from about 100,000 g/mol to about 200,000 g/mol.

In some embodiments, the number-average molecular weight of the water-compatible copolymer is less than 500,000 g/mol, less than 400,000 g/mol, less than 300,000 g/mol, less than 200,000 g/mol, less than 150,000 g/mol, less than 100,000 g/mol, less than 90,000 g/mol, less than 80,000 g/mol, less than 70,000 g/mol, less than 60,000 g/mol, less than 50,000 g/mol, less than 45,000 g/mol, or less than 40,000 g/mol. In some embodiments, the number-average molecular weight of the water-compatible copolymer is more than 10,000 g/mol, more than 20,000 g/mol, more than 30,000 g/mol, more than 40,000 g/mol, more than 45,000 g/mol, more than 50,000 g/mol, more than 60,000 g/mol, more than 70,000 g/mol, more than 80,000 g/mol, more than 90,000 g/mol, more than 100,000 g/mol, more than 150,000 g/mol, more than 200,000 g/mol, more than 300,000 g/mol, or more than 400,000 g/mol.

In some embodiments, the polydispersity index (PDI) of the water-compatible copolymer is from about 1 to about 20, from about 1 to about 15, from about 1 to about 10, from about 1 to about 5, from about 1 to about 4.8, from about 1 to about 4.5, from about 1 to about 4.2, from about 1 to about 4, from about 1 to about 3.8, from about 1 to about 3.5, from about 1 to about 3.2, from about 1 to about 3, from about 1.2 to about 20, from about 1.2 to about 15, from about 1.2 to about 10, from about 1.2 to about 5, from about 1.2 to about 4.8, from about 1.2 to about 4.5, from about 1.2 to about 4.2, from about 1.2 to about 4, from about 1.2 to about 3.8, from about 1.2 to about 3.6, from about 1.2 to about 3.4, from about 1.2 to about 3.2, from about 1.2 to about 3, from about 1.4 to about 20, from about 1.4 to about 15, from about 1.4 to about 10, from about 1.4 to about 5, from about 1.4 to about 4.8, from about 1.4 to about 4.5, from about 1.4 to about 4.2, from about 1.4 to about 4, from about 1.4 to about 3.8, from about 1.4 to about 3.5, from about 1.4 to about 3.2, from about 1.4 to about 3, from about 1.6 to about 20, from about 1.6 to about 15, from about 1.6 to about 10, from about 1.6 to about 5, from about 1.6 to about 4.8, from about 1.6 to about 4.5, from about 1.6 to about 4.2, from about 1.6 to about 4, from about 1.6 to about 3.8, from about 1.6 to about 3.5, from about 1.8 to about 20, from about 1.8 to about 15, from about 1.8 to about 10, from about 1.8 to about 5, from about 1.8 to about 4.8, from about 1.8 to about 4.5, from about 1.8 to about 4.2, from about 1.8 to about 4, from about 1.8 to about 3.8, from about 1.8 to about 3.5, from about 2 to about 20, from about 2 to about 15, from about 2 to about 10, from about 2 to about 5, from about 2 to about 4.8, from about 2 to about 4.5, from about 2 to about 4.2, from about 2 to about 4, from about 2 to about 3.8, from about 2 to about 3.5, from about 2.5 to about 20, from about 2.5 to about 15, from about 2.5 to about 10, from about 2.5 to about 5, from about 2.5 to about 4.8, from about 2.5 to about 4.5, from about 2.5 to about 4.2, from about 2.5 to about 4, from about 3 to about 20, from about 3 to about 15, from about 3 to about 10, from about 3 to about 5, from about 3 to about 4.8, from about 3 to about 4.6, or from about 3 to about 4.5.

In some embodiments, the polydispersity index of the water-compatible copolymer is less than 20, less than 15, less than 10, less than 5, less than 4.8, less than 4.5, less than 4.2, less than 4, less than 3.8, less than 3.5, less than 3.2, less than 3, less than 2.8, less than 2.5, less than 2.2, less than 2, less than 1.8, or less than 1.5. In some embodiments, the polydispersity index of the water-compatible copolymer is more than 1, more than 1.2, more than 1.5, more than 1.8, more than 2, more than 2.2, more than 2.5, more than 2.8, more than 3, more than 3.2, more than 3.5, more than 3.8, more than 4, more than 4.2, more than 4.5, more than 4.8, more than 5, more than 10, or more than 15.

When the polydispersity index of the water-compatible copolymer is within the ranges set forth above, each molecule of the copolymer has a similar weight, so the copolymer can be distributed more uniformly in the dry electrode mixture or electrode slurry.

In conventional methods of preparing water-based binder compositions, the post-reaction mixture obtained following polymerization would be a wet binder composition. This wet binder composition would be the final product and would be used directly in an electrode slurry. However, the wet binder composition comprises a large amount of aqueous medium: in some cases, the liquid content of the wet binder composition can be more than 80% of the total weight of the wet binder composition. While such a high liquid content allows for excellent dispersion of the water-compatible copolymer, it renders storage and transport of the binder composition highly inefficient. Therefore, a binder composition with a reduced liquid content is desirable.

Therefore, in some embodiments, the post-reaction mixture is dried to remove liquid and form a binder composition with a reduced liquid content. In some embodiments, a dry binder composition is formed by drying the post-reaction mixture until there is substantially no liquid left. In certain embodiments, a dry binder composition is formed by drying the post-reaction mixture until it is completely free of liquid.

In some embodiments, the liquid content of the dry binder composition is less than 1%, less than 0.8%, less than 0.6%, less than 0.5%, less than 0.4%, less than 0.3%, less than 0.25%, less than 0.2%, less than 0.15%, less than 0.1%, less than 0.05%, less than 0.04%, less than 0.03%, less than 0.025%, less than 0.02%, less than 0.015%, less than 0.01%, less than 0.008%, less than 0.005%, less than 0.003%, less than 0.002%, or less than 0.001% by weight, based on the total weight of the dry binder composition.

There is no particular limitation on the dryer used, except the dryer should be able to reduce the liquid content of the post-reaction mixture without degrading the copolymer within said mixture. In some embodiments, the dryer is a spray dryer, freeze dryer, pan dryer, rotary dryer, screw dryer, fluidized bed dryer, drum dryer, vacuum dryer, or combinations thereof.

In some embodiments, the dry binder composition is in the form of particles. In some embodiments, the particle size D50 of the dry binder composition particles is from about 10 µm to about 50 µm, from about 12 µm to about 50 µm, from about 14 µm to about 50 µm, from about 16 µm to about 50 µm, from about 18 µm to about 50 µm, from about 20 µm to about 50 µm, from about 20 µm to about 48 µm, from about 20 µm to about 46 µm, from about 20 µm to about 44 µm, from about 20 µm to about 42 µm, from about 20 µm to about 40 µm, from about 22 µm to about 40 µm, from about 22 µm to about 38 µm, from about 24 µm to about 38 µm, from about 24 µm to about 36 µm, from about 26 µm to about 34 µm, from about 28 µm to about 34 µm, or from about 28 µm to about 32 µm.

In some embodiments, the particle size D50 of the dry binder composition particles is less than 50 µm, less than 48 µm, less than 46 µm, less than 44 µm, less than 42 µm, less than 40 µm, less than 38 µm, less than 36 µm, less than 34 µm, less than 32 µm, less than 30 µm, less than 28 µm, less than 26 µm, less than 24 µm, less than 22 µm, less than 20 µm, less than 18 µm, less than 16 µm, less than 14 µm, or less than 12 µm.In some embodiments, the particle size D50 of the dry binder composition particles is more than 10 µm, more than 12 µm, more than 14 µm, more than 16 µm, more than 18 µm, more than 20 µm, more than 22 µm, more than 24 µm, more than 26 µm, more than 28 µm, more than 30 µm, more than 32 µm, more than 34 µm, more than 36 µm, more than 38 µm, more than 40 µm, more than 42 µm, more than 44 µm, more than 46 µm, or more than 48 µm.

By drying the binder composition until there is substantially no liquid left, maximum efficiency in storage and transport can be attained, since any remaining liquid within the dry binder composition would take up negligible mass and volume. A dry binder composition can be used to produce a dry electrode mixture or electrode slurry, which can in turn be coated onto a current collector to form an electrode.

In other embodiments, the binder composition is a semi-dry binder composition. In some embodiments, the semi-dry binder composition is obtained by directly drying the post-reaction mixture to the desired solid content percentage. In such cases, the semi-dry binder composition would have an aqueous solvent that is the same as or is derived from the aqueous medium of the polymerization process. In other embodiments, for more precise control the liquid content of the binder composition, the semi-dry binder composition is obtained by partially rehydrating the dry binder composition disclosed above.

In some embodiments, an aqueous solvent is added to the dry binder composition to rehydrate it into a semi-dry binder composition. Any aqueous solvent suitable as the aqueous medium of the polymerization process is also suitable for rehydrating the dry binder composition into a semi-dry binder composition. In some embodiments, the aqueous solvent used to rehydrate the dry binder composition and the aqueous medium of the polymerization process have the same composition. In other embodiments, the aqueous solvent used to rehydrate the dry binder composition and the aqueous medium of the polymerization process have different compositions.

In other embodiments, to rehydrate a dry binder composition into a semi-dry binder composition, the dry binder composition is placed in a humid environment to absorb moisture from the humid environment. This moisture then acts as the aqueous solvent for rehydration. In some embodiments, the binder composition is stirred while being rehydrated to ensure that all of the binder composition can be rehydrated by the humid environment. There is no particular limitation to the stirring speed of the binder composition while being rehydrated, except that the stirring speed should be sufficient fast to promote rehydration of all of the binder composition. In other embodiments, the binder composition is not stirred while being rehydrated.

In some embodiments, the humid environment is a controlled environment. In some embodiments, the controlled environment is a glovebox. In some embodiments, the controlled environment is an incubator. In some embodiments, the controlled environment is at room temperature. In other embodiments, the humid environment can refer to an open-air environment, as long as the humidity of the open-air environment is sufficiently high.

There is no particular limitation on the humidity of the humid environment, except that the specific humidity of the humid environment should be greater than the liquid content of the dry binder composition in order to ensure that the dry binder composition does absorb moisture from the humid environment to form the semi-dry binder composition. In some embodiments, the specific humidity of the humid environment is more than 0.1 g/kg, more than 0.15 g/kg, more than 0.2 g/kg, more than 0.25 g/kg, more than 0.5 g/kg, more than 1 g/kg, more than 1.5 g/kg, more than 2 g/kg, more than 3 g/kg, more than 4 g/kg, more than 5 g/kg, more than 6 g/kg, more than 8 g/kg, more than 10 g/kg, more than 12.5 g/kg, more than 15 g/kg, more than 20 g/kg, more than 30 g/kg, more than 40 g/kg, more than 50 g/kg, more than 75 g/kg, or more than 100 g/kg.

There is no particular limitation on the time period the dry binder composition is left in the humid environment, except that the time period should be sufficiently long as to allow for the dry binder composition to absorb moisture from the humid environment to form the semi-dry binder composition. In some embodiments, the dry binder composition is left in the humid environment for a time period of 5 minutes, 15 minutes, 30 minutes, 45 minutes, 60 minutes, 2 hours, 4 hours, 6 hours, 12 hours, 1 day, 2 days, 3 days, 1 week or 2 weeks.

In some embodiments the liquid content of the semi-dry binder composition is from about 1% to about 85%, from about 1% to about 80%, from about 1% to about 75%, from about 1% to about 70%, from about 1% to about 65%, from about 1% to about 60%, from about 1% to about 55%, from about 1% to about 50%, from about 1% to about 45%, from about 1% to about 40%, from about 1% to about 35%, from about 1% to about 30%, from about 1% to about 25%, from about 1% to about 20%, from about 10% to about 85%, from about 10% to about 80%, from about 10% to about 75%, from about 10% to about 70%, from about 10% to about 65%, from about 10% to about 60%, from about 10% to about 55%, from about 10% to about 50%, from about 10% to about 45%, from about 10% to about 40%, from about 10% to about 35%, from about 10% to about 30%, from about 10% to about 25%, from about 20% to about 85%, from about 20% to about 80%, from about 20% to about 75%, from about 20% to about 70%, from about 20% to about 65%, from about 20% to about 60%, from about 20% to about 55%, from about 20% to about 50%, from about 20% to about 45%, from about 20% to about 40%, from about 30% to about 85%, from about 30% to about 80%, from about 30% to about 75%, from about 30% to about 70%, from about 30% to about 65%, from about 30% to about 60%, from about 30% to about 55%, from about 30% to about 50%, from about 40% to about 85%, from about 40% to about 80%, from about 40% to about 75%, from about 40% to about 70%, from about 40% to about 65%, or from about 40% to about 60% by weight, based on the total weight of the semi-dry binder composition.

In some embodiments, the liquid content of the semi-dry binder composition is about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, or about 85% by weight, based on the total weight of the semi-dry binder composition.

In some embodiments, the liquid content of the semi-dry binder composition is less than 85%, less than 80%, less than 75%, less than 70%, less than 65%, less than 60%, less than 55%, less than 50%, less than 45%, less than 40%, less than 35%, less than 30%, less than 25%, less than 20%, less than 15%, or less than 10% by weight, based on the total weight of the semi-dry binder composition. In some embodiments, the liquid content of the semi-dry binder composition is more than 1%, more than 5%, more than 10%, more than 15%, more than 20%, more than 25%, more than 30%, more than 35%, more than 40%, more than 45%, more than 50%, more than 55%, more than 60%, more than 65%, more than 70%, or more than 75% by weight, based on the total weight of the semi-dry binder composition.

Although the lack of liquid content in dry binder compositions helps to improve logistical efficiency, it does not necessarily mean that it is always best to keep the liquid content of the binder composition as low as possible. The aqueous solvent of a semi-dry binder composition can reduce the risk of powder explosions and lessen the effects of static electricity. A semi-dry binder composition can be used to produce an electrode slurry, which can in turn be coated onto a current collector to form an electrode.

In some embodiments, apart from the binder composition, the dry electrode mixture or electrode slurry comprises an electrode active material. Such an electrode active material can be a cathode active material or an anode active material. When the dry electrode mixture or electrode slurry comprises a cathode active material, the dry electrode mixture or electrode slurry can be termed a cathode mixture and a cathode slurry respectively. When the dry electrode mixture or electrode slurry comprises an anode active material, the dry electrode mixture or electrode slurry can be termed an anode mixture and an anode slurry respectively. In some embodiments, the dry electrode mixture or electrode slurry further comprises a conductive agent.

Many cathode active materials are unstable in water and would react with it, forming unwanted impurities such as lithium hydroxide (LiOH). The presence of these impurities would lead to decreased battery electrochemical performance. Methods of waterproofing these cathode active materials have been devised, for example, coating cathode active materials to form core-shell cathode active materials. However, these methods can increase production costs and times and even adversely affect battery performance. By using a dry electrode mixture to form an electrode, the degradation of cathode active material due to reaction with water can be prevented.

The dry electrode mixture can be prepared with the dry binder composition disclosed herein, with no solvent added in the preparation of the dry electrode mixture. The dry electrode mixture would thus comprise an electrode active material and a dry binder composition, and optionally a conductive agent, but would be substantially free of or would not comprise any liquid.

In some embodiments, the liquid content of the dry electrode mixture is less than 1%, less than 0.8%, less than 0.6%, less than 0.5%, less than 0.4%, less than 0.3%, less than 0.25%, less than 0.2%, less than 0.15%, less than 0.1%, less than 0.05%, less than 0.04%, less than 0.03%, less than 0.025%, less than 0.02%, less than 0.015%, less than 0.01%, less than 0.008%, less than 0.005%, less than 0.003%, less than 0.002%, or less than 0.001% by weight, based on the total weight of the dry electrode mixture.

Conversely, an electrode slurry does comprise liquid. The electrode slurry can be prepared with the dry or semi-dry binder composition disclosed herein. The liquid portion of the electrode slurry consists of an aqueous solvent, such as water, at least a portion of which can originate from the aqueous solvent of the semi-dry binder composition.

Because it comprises liquid, the electrode slurry can be readily applied onto a current collector to form an electrode without involving extreme conditions such as high temperatures and pressures. This improves the inherent safety of the coating process and saves on costs that would otherwise be incurred to adopt additional safety measures in the coating process. Safety is also improved by the fact that the risk of powder explosions is mitigated.

In addition, in electrode slurries with a relatively low liquid contents, such as those with a liquid content below 30% of the total slurry weight, water would primarily be embedded in the polymer chains and not directly exposed to other electrode components in the slurry. As a result, problems caused by the presence of water in an electrode slurry, such as the reaction of water with cathode active material, could be reduced.

Accordingly, in certain embodiments, an electrode slurry is prepared with a semi-dry binder composition, wherein no solvent is added in the preparation of the electrode slurry. In such cases, the liquid portion of the semi-dry binder composition, which consists of aqueous solvent, would be sufficient to provide for the liquid portion of the electrode slurry. The electrode slurry would thus comprise an electrode active material and a semi-dry binder composition, and optionally a conductive agent. In other embodiments, an electrode slurry is prepared with a dry or semi-dry binder composition disclosed herein, wherein additional solvent is added in the preparation of an electrode slurry. The electrode slurry would then comprise an electrode active material, a dry binder composition or a semi-dry binder composition and additional solvent, and optionally a conductive agent.

As disclosed above, it can be seen that a dry electrode mixture and an electrode slurry both have their respective advantages. Accordingly, the binder composition disclosed herein may be used as a binder composition of a dry electrode mixture or an electrode slurry depending on production needs.

There is no particular limitation on the method used to produce the dry electrode mixture or electrode slurry, except that all electrode components should be well mixed to form a homogenized dry electrode mixture or electrode slurry; this can be achieved by using a homogenizer, for example. In some embodiments, all the materials used to produce the dry electrode mixture or electrode slurry are added into the homogenizer in a single batch. In other embodiments, each component (e.g., electrode active material, binder composition, and optionally conductive agent) of the dry electrode mixture or electrode slurry can be added to the homogenizer in several batches, and each batch may comprise more than one electrode component.

In some embodiments, when additional solvent is added to the electrode slurry, the additional solvent is an aqueous solvent. Any aqueous solvent suitable as the aqueous medium of the polymerization process, and/or as the aqueous solvent in the rehydration of the dry binder composition into the semi-dry binder composition, is also suitable for use as the additional solvent in the electrode slurry. In some embodiments, when additional solvent is added in the preparation of the electrode slurry, the additional solvent can be added before, after and/or during homogenization of the electrode components in one or more batches.

In some embodiments, when additional solvent is added to the electrode slurry, the additional solvent and the aqueous medium of the polymerization process have the same composition. In some embodiments, when additional solvent is added to the electrode slurry, the additional solvent and the aqueous solvent used to rehydrate the dry binder composition into the semi-dry binder composition have the same composition. In some embodiments, when additional solvent is added to the electrode slurry, the additional solvent, the aqueous medium of the polymerization process, and the aqueous solvent used to rehydrate the dry binder composition into the semi-dry binder composition all have the same composition. In other embodiments, when additional solvent is added to the electrode slurry, two or more of the additional solvent, the aqueous medium of the polymerization process, and the aqueous solvent used to rehydrate the dry binder composition into the semi-dry binder composition have different compositions.

In other embodiments, an electrode slurry is formed by placing a dry electrode mixture in a humid environment to absorb moisture from the humid environment. This moisture then acts as the additional solvent. When this method is used, it is likely that the liquid content of the electrode slurry would be relatively lower compared to that of a conventional electrode slurry. In some embodiments, the humid environment is a controlled environment. In some embodiments, the controlled environment is a glovebox. In some embodiments, the controlled environment is an incubator. In some embodiments, the controlled environment is at room temperature. In other embodiments, the humid environment can refer to an open-air environment, as long as the humidity of the open-air environment is sufficiently high.

There is no particular limitation on the humidity of the humid environment, except that the specific humidity of the humid environment should be greater than the liquid content of the dry electrode mixture in order to ensure that the dry electrode mixture does absorb moisture from the humid environment to form the electrode slurry. In some embodiments, the specific humidity of the humid environment is more than 0.1 g/kg, more than 0.15 g/kg, more than 0.2 g/kg, more than 0.25 g/kg, more than 0.5 g/kg, more than 1 g/kg, more than 1.5 g/kg, more than 2 g/kg, more than 3 g/kg, more than 4 g/kg, more than 5 g/kg, more than 6 g/kg, more than 8 g/kg, more than 10 g/kg, more than 12.5 g/kg, more than 15 g/kg, more than 20 g/kg, more than 30 g/kg, more than 40 g/kg, more than 50 g/kg, more than 75 g/kg, or more than 100 g/kg.

There is no particular limitation on the time period the dry electrode mixture is left in the humid environment, except that the time period should be sufficiently long as to allow for the dry electrode mixture to absorb moisture from the humid environment to form the electrode slurry. In some embodiments, the dry electrode mixture is left in the humid environment for a period of 5 minutes, 15 minutes, 30 minutes, 45 minutes, 60 minutes, 2 hours, 4 hours, 6 hours, 12 hours, 1 day, 2 days, 3 days, 1 week or 2 weeks.

In some embodiments, the electrode active material is a cathode active material selected from the group consisting of LiCoO₂, LiNiO₂, LiNiₓMn_{y}O₂, LiCoₓNi_{y}O₂, Li_{1+z}NiₓMn-_{y}Co_{1-x-y}O₂ (NMC), LiNiₓCo_{y}Al_{z}O₂ (NCA), LiV₂O₅, LiTiS₂, LiMoS₂, LiMnO₂, LiCrO₂, LiMn₂O₄, Li₂MnO₃, LiFeO₂, LiFePO₄, and combinations thereof, wherein each x is independently from 0.1 to 0.9; each y is independently from 0 to 0.9; and each z is independently from 0 to 0.4. In some embodiments, each x, y and z in the above general formula independently has a 0.01 interval. In other embodiments, the cathode active material is not LiCoO₂, LiNiO₂, LiV₂O₅, LiTiS₂, LiMoS₂, LiMnO₂, LiCrO₂, LiMn₂O₄, LiFeO₂, or LiFePO₄. In further embodiments, the cathode active material is not LiNiₓMn_{y}O₂, Li_{1+z}NiₓMn_{y}Co_{1-x-y}O₂, LiNiₓCo_{y}Al_{z}O₂ or LiCoₓNi_{y}O₂, wherein each x is independently from 0.1 to 0.9; each y is independently from 0 to 0.9; and each z is independently from 0 to 0.4. In certain embodiments, the cathode active material is Li₁₊ₓNiₐMn_{b}Co_{c}Al_{(1-a-b-c})O₂; wherein -0.2≤x≤0.2, 0≤a<1, 0≤b<1, 0≤c<1, and a+b+c≤1. In some embodiments, the cathode active material has the general formula LiMPO₄, wherein M is selected from the group consisting of Fe, Co, Ni, Mn, Al, Mg, Zn, Ti, La, Ce, Sn, Zr, Ru, Si, Ge, or combinations thereof. In some embodiments, the cathode active material is selected from the group consisting of LiFePO₄, LiCoPO₄, LiNiPO₄, LiMnPO₄, LiMnFePO₄, LiMnₓFe₍₁₋ₓ₎PO₄, and combinations thereof; wherein 0<x<1. In some embodiments, the cathode active material is LiNiₓMn_{y}O₄; wherein 0.1≤x≤0.9 and 0≤y≤2. In certain embodiments, the cathode active material is xLi₂MnO₃•(1-x)LiMO₂, wherein M is selected from the group consisting of Ni, Co, Mn, and combinations thereof; and wherein 0<x<1. In some embodiments, the cathode active material is Li₃V₂(PO₄)₃, or LiVPO₄F. In certain embodiments, the cathode active material has the general formula Li₂MSiO₄, wherein M is selected from the group consisting of Fe, Co, Mn, Ni, and combinations thereof.

In certain embodiments, the cathode active material is doped with a dopant selected from the group consisting of Co, Cr, V, Mo, Nb, Pd, F, Na, Fe, Ni, Mn, Al, Mg, Zn, Ti, La, Ce, Sn, Zr, Ru, Si, Ge, and combinations thereof. In some embodiments, the dopant is not Co, Cr, V, Mo, Nb, Pd, F, Na, Fe, Ni, Mn, Mg, Zn, Ti, La, Ce, Ru, Si, or Ge. In certain embodiments, the dopant is not Al, Sn, or Zr.

In certain embodiments, the cathode active material comprises or is a core-shell composite having a core and shell structure. In some embodiments, the core comprises one or more lithium transition metal oxides. In some embodiments, the shell comprises one or more lithium transition metal oxides and/or one or more transition metal oxides. In some embodiments, the one or more lithium transition metal oxides are selected from the group consisting of Li₁₊ₓNiₐMn_{b}Co_{c}Al_{(1-a-b-c)}O₂, LiCoO₂, LiNiO₂, LiMnO₂, LiMn₂O₄, Li₂MnO₃, LiCrO₂, Li4Ti₅O₁₂, LiV₂O₅, LiTiS₂, LiMoS₂, LiCoₐNi_{b}O₂, LiMnₐNi_{b}O₂, and combinations thereof; wherein -0.2≤x≤0.2, 0≤a<1, 0≤b<1, 0≤c<1, and a+b+c≤1. In some embodiments, each of the lithium transition metal oxides is independently doped with one or more dopants selected from the group consisting of Co, Cr, V, Mo, Nb, Pd, F, Na, Fe, Ni, Mn, Al, Mg, Zn, Ti, La, Ce, Sn, Zr, Ru, Si, Ge, and combinations thereof. In some embodiments, the one or more transition metal oxides are selected from the group consisting of Fe₂O₃, MnO₂, Al₂O₃, MgO, ZnO, TiO₂, La₂O₃, CeO₂, SnO₂, ZrO₂, RuO₂, and combinations thereof.

In some embodiments, each of the shell and the core comprises one or more lithium transition metal oxides. In some embodiments, the lithium transition metal oxides in the core and the shell may be the same, or they may be different or partially different. In some embodiments, when the core or the shell comprises two or more lithium transition metal oxides, the two or more lithium transition metal oxides are uniformly distributed over the core or the shell. In certain embodiments, when the core or the shell comprises two or more lithium transition metal oxides, the two or more lithium transition metal oxides are not uniformly distributed over the core or the shell. In some embodiments, the cathode active material is not a core-shell composite.

In certain embodiments, the thickness of the shell and the diameter of the core are each independently from about 1 µm to about 45 µm, from about 1 µm to about 25 µm, from about 1 µm to about 15 µm, from about 1 µm to about 5 µm, from about 3 µm to about 15 µm, from about 5 µm to about 10 µm, from about 10 µm to about 35 µm, from about 15 µm to about 30 µm, from about 15 µm to about 25 µm, or from about 20 µm to about 30 µm.In certain embodiments, the diameter or thickness ratio of the core and the shell are in the range of 15:85 to 85:15, 25:75 to 75:25, 30:70 to 70:30, or 40:60 to 60:40. In certain embodiments, the volume or weight ratio of the core and the shell is 95:5, 90:10, 80:20, 70:30, 60:40, 50:50, 40:60, or 30:70.

In some embodiments, the electrode active material is an anode active material selected the group consisting of natural graphite particulate, synthetic graphite particulate, hard carbon, soft carbon, mesocarbon microbeads (MCMB), Sn particulate, SnO₂, SnO, Li₄Ti₅O₁₂ particulate, Si particulate, Si—C composite particulate, and combinations thereof.

In certain embodiments, the anode active material is doped with a dopant. In some embodiments, the dopant is selected from the group consisting of Fe, Ni, Mn, Al, Mg, Zn, Ti, La, Ce, Sn, Zr, Ru, and combinations thereof. In some embodiments, the dopant is B, Si, Ge, N, P, F, S, Cl, I, Se, or combinations thereof. In other embodiments, the anode active material is not doped. In some embodiments, the anode active material is not doped with Fe, Ni, Mn, Al, Mg, Zn, Ti, La, Ce, Sn, Zr, Ru, B, Si, Ge, N, P, F, S, Cl, I, or Se.

In some embodiments, the anode active material comprises or is a core-shell composite having a core and shell structure. In some embodiments, the core is selected from the group consisting of natural graphite particulate, synthetic graphite particulate, hard carbon, soft carbon, mesocarbon microbeads (MCMB), Sn particulate, SnO₂, SnO, Li₄Ti₅O₁₂ particulate, Si particulate, Si—C composite particulate, and combinations thereof. In some embodiments, the shell is selected from the group consisting of soft carbon, hard carbon, natural graphite particulate, synthetic graphite particulate, mesocarbon microbeads (MCMB), Kish graphite, pyrolytic carbon, mesophase pitches, mesophase pitch-based carbon fiber, Sn particulate, SnO₂, SnO, Li₄Ti₅O₁₂ particulate, Si particulate, Si—C composite particulate, and combinations thereof.

In some embodiments, the dry electrode mixture or electrode slurry may additionally comprise a conductive agent. The conductive agent enhances the electrically-conducting properties of an electrode. Therefore, it may be advantageous for the dry electrode mixture or electrode slurry to comprise a conductive agent. Any suitable material can act as the conductive agent. In some embodiments, the conductive agent is a carbonaceous material. Some non-limiting examples include carbon, carbon black, graphite, expanded graphite, graphene, graphene nanoplatelets, carbon fibers, carbon nano-fibers, graphitized carbon flake, carbon tubes, carbon nanotubes, activated carbon, Super P, KS6, vapor grown carbon fibers (VGCF), mesoporous carbon, and combinations thereof. In certain embodiments, the conductive agent does not comprise a carbonaceous material.

In some embodiments, the conductive agent is a conductive polymer selected from the group consisting of polypyrrole, polyaniline, polyacetylene, polyphenylene sulfide (PPS), polyphenylene vinylene (PPV), poly(3,4-ethylenedioxythiophene) (PEDOT), polythiophene, and combinations thereof. In some embodiments, the conductive agent also acts as a binder composition. In some embodiments, the conductive agent is a mixture of a carbonaceous material and a conductive polymer. In other embodiments, the conductive agent does not comprise a conductive polymer.

The dry electrode mixture or electrode slurry can comprise additives as needed to obtain the desired electrode properties. In certain embodiments, the additive is a conductive polymer that is used in addition to the conductive agent. In some embodiments, the additive is a dispersant or surfactant to facilitate the homogenization of the electrode mixture or slurry.

In some embodiments, the proportion of binder copolymer in the dry electrode mixture or the solid portion of the electrode slurry is from about 1% to about 50%, from about 2% to about 50%, from about 5% to about 50%, from about 8% to about 50%, from about 10% to about 50%, from about 15% to about 50%, from about 20% to about 50%, from about 25% to about 50%, from about 30% to about 50%, from about 1% to about 40%, from about 2% to about 40%, from about 5% to about 40%, from about 8% to about 40%, from about 10% to about 40%, from about 15% to about 40%, from about 20% to about 40%, from about 25% to about 40%, from about 1% to about 30%, from about 2% to about 30%, from about 5% to about 30%, from about 8% to about 30%, from about 10% to about 30%, from about 15% to about 30%, from about 20% to about 30%, from about 1% to about 20%, from about 2% to about 20%, from about 5% to about 20%, from about 8% to about 20%, from about 10% to about 20%, from about 15% to about 20%, from about 1% to about 10%, from about 2% to about 10%, from about 5% to about 10%, from about 1% to about 5%, or from about 2% to about 5% by weight, based on the total weight of the dry electrode mixture or solid portion of the electrode slurry respectively.

In some embodiments, the proportion of binder copolymer in the dry electrode mixture or the solid portion of the electrode slurry is less than 50%, less than 45%, less than 40%, less than 35%, less than 30%, less than 25%, less than 20%, less than 15%, less than 10%, less than 8%, or less than 5% by weight, based on the total weight of the dry electrode mixture or solid portion of the electrode slurry respectively. In some embodiments, the proportion of binder copolymer in the dry electrode mixture or the solid portion of the electrode slurry is more than 1%, more than 2%, more than 5%, more than 8%, more than 10%, more than 15%, more than 20%, more than 25%, more than 30%, more than 35%, or more than 40% by weight, based on the total weight of the dry electrode mixture or solid portion of the electrode slurry respectively.

In some embodiments, the proportion of conductive agent in the dry electrode mixture or the solid portion of the electrode slurry is from about 1% to about 20%, from about 2% to about 20%, from about 5% to about 20%, from about 8% to about 20%, from about 10% to about 20%, from about 15% to about 20%, from about 1% to about 10%, from about 2% to about 10%, from about 5% to about 10%, from about 1% to about 5%, or from about 2% to about 5% by weight, based on the total weight of the dry electrode mixture or solid portion of the electrode slurry respectively.

In some embodiments, the proportion of conductive agent in the dry electrode mixture or the solid portion of the electrode slurry is less than 20%, less than 15%, less than 10%, less than 8%, or less than 5% by weight, based on the total weight of the dry electrode mixture or solid portion of the electrode slurry respectively. In some embodiments, the proportion of conductive agent in the dry electrode mixture or the solid portion of the electrode slurry is more than 1%, more than 2%, more than 5%, more than 8%, more than 10%, or more than 15% by weight, based on the total weight of the dry electrode mixture or solid portion of the electrode slurry respectively.

In some embodiments, the proportion of electrode active material in the dry electrode mixture or the solid portion of the electrode slurry is from about 40% to about 99%, from about 45% to about 99%, from about 50% to about 99%, from about 55% to about 99%, from about 60% to about 99%, from about 65% to about 99%, from about 70% to about 99%, from about 75% to about 99%, from about 80% to about 99%, from about 40% to about 95%, from about 45% to about 95%, from about 50% to about 95%, from about 55% to about 95%, from about 60% to about 95%, from about 65% to about 95%, from about 70% to about 95%, from about 75% to about 95%, from about 80% to about 95%, from about 40% to about 90%, from about 45% to about 90%, from about 50% to about 90%, from about 55% to about 90%, from about 60% to about 90%, from about 65% to about 90%, from about 70% to about 90%, from about 75% to about 90%, from about 80% to about 90%, from about 40% to about 85%, from about 45% to about 85%, from about 50% to about 85%, from about 55% to about 85%, from about 60% to about 85%, from about 65% to about 85%, from about 70% to about 85%, or from about 75% to about 85% by weight, based on the total weight of the dry electrode mixture or solid portion of the electrode slurry respectively.

In some embodiments, the proportion of electrode active material in the dry electrode mixture or the solid portion of the electrode slurry is less than 99%, less than 95%, less than 90%, less than 85%, less than 80%, less than 75%, less than 70%, less than 65%, less than 60%, less than 55%, or less than 50% by weight, based on the total weight of the dry electrode mixture or solid portion of the electrode slurry respectively. In some embodiments, the proportion of electrode active material in the dry electrode mixture or the solid portion of the electrode slurry is more than 40%, more than 45%, more than 50%, more than 55%, more than 60%, more than 65%, more than 70%, more than 75%, more than 80%, or more than 85% by weight, based on the total weight of the dry electrode mixture or solid portion of the electrode slurry respectively.

In some embodiments, the proportion of additional solvent added to the electrode slurry is from about 0% to about 60%, from about 2% to about 60%, from about 5% to about 60%, from about 8% to about 60%, from about 10% to about 60%, from about 12% to about 60%, from about 15% to about 60%, from about 18% to about 60%, from about 20% to about 60%, from about 22% to about 60%, from about 25% to about 60%, from about 28% to about 60%, from about 30% to about 60%, from about 32% to about 60%, from about 35% to about 60%, from about 38% to about 60%, from about 40% to about 60%, from about 42% to about 60%, from about 45% to about 60%, from about 0% to about 50%, from about 2% to about 50%, from about 5% to about 50%, from about 8% to about 50%, from about 10% to about 50%, from about 12% to about 50%, from about 15% to about 50%, from about 18% to about 50%, from about 20% to about 50%, from about 22% to about 50%, from about 25% to about 50%, from about 28% to about 50%, from about 30% to about 50%, from about 32% to about 50%, from about 35% to about 50%, from about 0% to about 40%, from about 2% to about 40%, from about 5% to about 40%, from about 8% to about 40%, from about 10% to about 40%, from about 12% to about 40%, from about 15% to about 40%, from about 18% to about 40%, from about 20% to about 40%, from about 22% to about 40%, from about 25% to about 40%, from about 28% to about 40%, from about 30% to about 40%, from about 0% to about 30%, from about 2% to about 30%, from about 5% to about 30%, from about 8% to about 30%, from about 10% to about 30%, from about 12% to about 30%, from about 15% to about 30%, from about 18% to about 30%, from about 20% to about 30%, from about 0% to about 20%, from about 2% to about 20%, from about 5% to about 20%, from about 8% to about 20%, from about 10% to about 20%, from about 0% to about 15%, from about 3% to about 15%, or from about 5% to about 15% by weight, based on the total weight of the slurry.

In some embodiments, the proportion of additional solvent added to the electrode slurry is less than 60%, less than 58%, less than 55%, less than 52%, less than 50%, less than 48%, less than 45%, less than 42%, less than 40%, less than 38%, less than 35%, less than 32%, less than 30%, less than 28%, less than 25%, less than 22%, less than 20%, less than 18%, less than 15%, less than 12%, less than 10%, less than 8% or less than 5% by weight, based on the total weight of the slurry. In some embodiments, the proportion of additional solvent added to the electrode slurry is more than 0%, more than 2%, more than 5%, more than 8%, more than 10%, more than 12%, more than 15%, more than 18%, more than 20%, more than 22%, more than 25%, more than 28%, more than 30%, more than 32%, more than 35%, more than 38%, more than 40%, more than 42%, more than 45%, more than 48%, more than 50%, or more than 52% by weight, based on the total weight of the slurry.

In some embodiments, the liquid content of the electrode slurry is from about 1% to about 60%, from about 3% to about 60%, from about 5% to about 60%, from about 8% to about 60%, from about 10% to about 60%, from about 12% to about 60%, from about 15% to about 60%, from about 18% to about 60%, from about 20% to about 60%, from about 23% to about 60%, from about 25% to about 60%, from about 28% to about 60%, from about 30% to about 60%, from about 33% to about 60%, from about 35% to about 60%, from about 38% to about 60%, from about 40% to about 60%, from about 43% to about 60%, from about 45% to about 60%, from about 1% to about 50%, from about 3% to about 50%, from about 5% to about 50%, from about 8% to about 50%, from about 10% to about 50%, from about 12% to about 50%, from about 15% to about 50%, from about 18% to about 50%, from about 20% to about 50%, from about 23% to about 50%, from about 25% to about 50%, from about 28% to about 50%, from about 30% to about 50%, from about 33% to about 50%, from about 35% to about 50%, from about 1% to about 40%, from about 3% to about 40%, from about 5% to about 40%, from about 8% to about 40%, from about 10% to about 40%, from about 12% to about 40%, from about 15% to about 40%, from about 18% to about 40%, from about 20% to about 40%, from about 23% to about 40%, from about 25% to about 40%, from about 1% to about 30%, from about 3% to about 30%, from about 5% to about 30%, from about 8% to about 30%, from about 10% to about 30%, from about 12% to about 30%, from about 15% to about 30%, from about 1% to about 20%, from about 3% to about 20%, from about 5% to about 20%, from about 8% to about 20%, from about 10% to about 20%, from about 1% to about 15%, from about 3% to about 15%, from about 5% to about 15%, or from about 1% to about 10% by weight, based on the total weight of the slurry.

In some embodiments, the liquid content of the electrode slurry is less than 60%, less than 58%, less than 55%, less than 53%, less than 50%, less than 48%, less than 45%, less than 43%, less than 40%, less than 38%, less than 35%, less than 33%, less than 30%, less than 28%, less than 25%, less than 23%, less than 20%, less than 18%, less than 15%, less than 12%, less than 10%, less than 8% or less than 5% by weight, based on the total weight of the slurry. In some embodiments, the liquid content of the electrode slurry is more than 1%, more than 3%, more than 5%, more than 8%, more than 10%, more than 12%, more than 15%, more than 18%, more than 20%, more than 23%, more than 25%, more than 28%, more than 30%, more than 33%, more than 35%, more than 38%, more than 40%, more than 43%, more than 45%, more than 48%, more than 50%, more than 53%, or more than 55% by weight, based on the total weight of the slurry.

The homogenizer may be equipped with a temperature control system and the temperature of the dry electrode mixture or electrode slurry can be controlled by the temperature control system. Any homogenizer that can reduce or eliminate particle aggregation, and/or promote homogeneous distribution of the electrode components within the dry electrode mixture or electrode slurry can be used herein. Homogeneous distribution plays an important role in fabricating batteries with good electrochemical performance. In some embodiments, the homogenizer is a tumbler, a mill, a stirring mixer, or a planetary mixer. In some embodiments, the homogenizer is grounded to reduce the effect of static electricity on the dry electrode mixture.

In some embodiments, the total homogenization time to produce the dry electrode mixture or electrode slurry is from about 1 minute to about 24 hours, from about 5 minutes to about 24 hours, from about 10 minutes to about 24 hours, from about 15 minutes to about 24 hours, from about 30 minutes to about 24 hours, from about 60 minutes to about 24 hours, from about 2 hours to about 24 hours, from about 4 hours to about 24 hours, from about 6 hours to about 24 hours, from about 8 hours to about 24 hours, from about 10 hours to about 24 hours, from about 12 hours to about 24 hours, from about 16 hours to about 24 hours, from about 1 minute to about 16 hours, from about 5 minutes to about 16 hours, from about 10 minutes to about 16 hours, from about 15 minutes to about 16 hours, from about 30 minutes to about 16 hours, from about 60 minutes to about 16 hours, from about 2 hours to about 16 hours, from about 4 hours to about 16 hours, from about 6 hours to about 16 hours, from about 8 hours to about 16 hours, from about 10 hours to about 16 hours, from about 12 hours to about 16 hours, from about 1 minute to about 12 hours, from about 5 minutes to about 12 hours, from about 10 minutes to about 12 hours, from about 15 minutes to about 12 hours, from about 30 minutes to about 12 hours, from about 60 minutes to about 12 hours, from about 2 hours to about 12 hours, from about 4 hours to about 12 hours, from about 1 minute to about 6 hours, from about 5 minutes to about 6 hours, from about 10 minutes to about 6 hours, from about 15 minutes to about 6 hours, from about 30 minutes to about 6 hours, from about 60 minutes to about 6 hours, from about 2 hours to about 6 hours, from about 1 minute to about 2 hours, from about 5 minutes to about 2 hours, from about 10 minutes to about 2 hours, from about 15 minutes to about 2 hours, or from about 30 minutes to about 2 hours.

In some embodiments, the total homogenization time to produce the dry electrode mixture or electrode slurry is less than 24 hours, less than 16 hours, less than 12 hours, less than 10 hours, less than 8 hours, less than 6 hours, less than 4 hours, less than 2 hours, less than 60 minutes, less than 30 minutes, or less than 15 minutes. In some embodiments, the total homogenization time to produce the dry electrode mixture or electrode slurry is more than 1 minute, more than 5 minutes, more than 10 minutes, more than 15 minutes, more than 30 minutes, more than 60 minutes, more than 2 hours, more than 4 hours, more than 6 hours, more than 8 hours, more than 10 hours, more than 12 hours, or more than 16 hours.

In some embodiments, the dry electrode mixture or electrode slurry is mixed at a temperature of from about 20° C. to about 90° C., from about 25° C. to about 90° C., from about 30° C. to about 90° C., from about 35° C. to about 90° C., from about 40° C. to about 90° C., from about 50° C. to about 90° C., from about 60° C. to about 90° C., from about 70° C. to about 90° C., from about 20° C. to about 80° C., from about 25° C. to about 80° C., from about 30° C. to about 80° C., from about 35° C. to about 80° C., from about 40° C. to about 80° C., from about 50° C. to about 80° C., from about 60° C. to about 80° C., from about 20° C. to about 70° C., from about 25° C. to about 70° C., from about 30° C. to about 70° C., from about 35° C. to about 70° C., from about 40° C. to about 70° C., from about 50° C. to about 70° C., from about 20° C. to about 60° C., from about 25° C. to about 60° C., from about 30° C. to about 60° C., from about 35° C. to about 60° C., or from about 40° C. to about 60° C.

In some embodiments, the dry electrode mixture or electrode slurry is mixed at a temperature of less than 90° C., less than 80° C., less than 70° C., less than 60° C., less than 50° C., or less than 40° C. In some embodiments, the dry electrode mixture or electrode slurry is mixed at a temperature of more than 20° C., more than 25° C., more than 30° C., more than 35° C., more than 40° C., more than 50° C., more than 60° C., or more than 70° C.

In certain embodiments, the rotational speed of each rotating element in the homogenizer is independently from about 100 rpm to about 3000 rpm, from about 500 rpm to about 3000 rpm, from about 1000 rpm to about 3000 rpm, from about 1500 rpm to about 3000 rpm, from about 100 rpm to about 2500 rpm, from about 500 rpm to about 2500 rpm, from about 1000 rpm to about 2500 rpm, from about 1500 rpm to about 2500 rpm, from about 100 rpm to about 2000 rpm, from about 500 rpm to about 2000 rpm, from about 1000 rpm to about 2000 rpm, from about 100 rpm to about 1500 rpm, or from about 500 rpm to about 1500 rpm.

In certain embodiments, the rotational speed of each rotating element in the homogenizer is independently less than 3000 rpm, less than 2500 rpm, less than 2000 rpm, less than 1500 rpm, or less than 1000 rpm. In certain embodiments, the rotational speed of each rotating element in the homogenizer is independently more than 100 rpm, more than 500 rpm, more than 1000 rpm, more than 1500 rpm, or more than 2000 rpm.

After homogenization, the dry electrode mixture or electrode slurry can be used to make an electrode. In some embodiments, the electrode comprises a current collector and an electrode layer formed on one or more surfaces of the current collector.

In some embodiments, after homogenization of the dry electrode mixture or electrode slurry, the dry electrode mixture or electrode slurry can be coated onto one side or both sides of a current collector to form a coated electrode film. In some embodiments, the dry electrode mixture or electrode slurry is applied or calendered directly onto a current collector. In some embodiments, the dry electrode mixture or electrode slurry is applied or calendered onto a release film to form a free-standing layer. The free-standing layer is then combined with a current collector and pressed to form the coated electrode film on the current collector.

In some embodiments, coating of a dry electrode mixture can be performed using a molding press, a roll press, an extrusion press, or a powder coater. In some embodiments, the molding press is a tablet press. In some embodiments, the extrusion press is a pellet mill, or a screw extruder. In certain embodiments, coating of an electrode slurry can be performed using a doctor blade coater, a slot-die coater, a transfer coater, a roll coater, a reverse coater, or a gravure coater.

The current collector acts to collect electrons generated by electrochemical reactions of the cathode active material or to supply electrons required for the electrochemical reactions. In some embodiments, the current collector can be in the form of a foil, sheet or film. In certain embodiments, the current collector is stainless steel, titanium, nickel, aluminum, copper, or alloys thereof; or electrically-conductive resin. In certain embodiments, the current collector has a two-layered structure comprising an outer layer and an inner layer, wherein the outer layer comprises a conductive material and the inner layer comprises an insulating material or another conductive material; for example, aluminum mounted with a conductive resin layer or a polymeric insulating material coated with an aluminum film. In some embodiments, the current collector has a three-layered structure comprising an outer layer, a middle layer and an inner layer, wherein the outer and inner layers comprise a conductive material and the middle layer comprises an insulating material or another conductive material; for example, a plastic substrate coated with a metal film on both sides. In certain embodiments, each of the outer layer, middle layer and inner layer is independently stainless steel, titanium, nickel, aluminum, copper, or alloys thereof; or electrically-conductive resin. In some embodiments, the insulating material is a polymeric material selected from the group consisting of polycarbonate, polyacrylate, polyacrylonitrile, polyester, polyamide, polystyrene, polyurethane, polyepoxy, poly(acrylonitrile-butadiene-styrene), polyimide, polyolefin, polyethylene, polypropylene, polyphenylene sulfide, poly(vinyl ester), polyvinyl chloride, polyether, polyphenylene oxide, cellulose polymer, and combinations thereof. In certain embodiments, the current collector has a structure comprising more than three layers.

In some embodiments, a conductive layer can be coated on the current collector to improve its current conductivity. In certain embodiments, the conductive layer comprises a material selected from the group consisting of carbon, carbon black, graphite, expanded graphite, graphene, graphene nanoplatelets, carbon fibers, carbon nano-fibers, graphitized carbon flake, carbon tubes, carbon nanotubes, activated carbon, mesoporous carbon, and combinations thereof. In some embodiments, the conductive layer does not comprise carbon, carbon black, graphite, expanded graphite, graphene, graphene nanoplatelets, carbon fibers, carbon nano-fibers, graphitized carbon flake, carbon tubes, carbon nanotubes, activated carbon, or mesoporous carbon.

In some embodiments, the conductive layer has a thickness of from about 0.5 µm to about 5.0 µm. Thickness of the conductive layer affects the volume occupied by the current collector within a battery, as well as the amount of the electrode active material needed and hence the capacity of the battery.

In certain embodiments, the thickness of the conductive layer on the current collector is from about 0.5 µm to about 4.5 µm, from about 1.0 µm to about 4.0 µm, from about 1.0 µm to about 3.5 µm, from about 1.0 µm to about 3.0 µm, from about 1.0 µm to about 2.5 µm, from about 1.0 µm to about 2.0 µm, from about 1.1 µm to about 2.0 µm, from about 1.2 µm to about 2.0 µm, from about 1.5 µm to about 2.0 µm, from about 1.8 µm to about 2.0 µm, from about 1.0 µm to about 1.8 µm, from about 1.2 µm to about 1.8 µm, from about 1.5 µm to about 1.8 µm, from about 1.0 µm to about 1.5 µm, or from about 1.2 µm to about 1.5 µm.In some embodiments, the thickness of the conductive layer on the current collector is less than 4.5 µm, less than 4.0 µm, less than 3.5 µm, less than 3.0 µm, less than 2.5 µm, less than 2.0 µm, less than 1.8 µm, less than 1.5 µm, or less than 1.2 µm.In some embodiments, the thickness of the conductive layer on the current collector is more than 1.0 µm, more than 1.2 µm, more than 1.5 µm, more than 1.8 µm, more than 2.0 µm, more than 2.5 µm, more than 3.0 µm, or more than 3.5 µm.

The thickness of the current collector affects the volume it occupies within the battery, and hence the energy density of the battery. In some embodiments, the current collector has a thickness of from about 5 µm to about 30 µm. In certain embodiments, the current collector has a thickness of from about 5 µm to about 20 µm, from about 5 µm to about 15 µm, from about 10 µm to about 30 µm, from about 10 µm to about 25 µm, or from about 10 µm to about 20 µm.

In some embodiments, following the coating of the dry electrode mixture or electrode slurry onto the current collector to form a coated film, the coated film is heated and/or dried. Any equipment that can heat and/or dry the coated film in order to affix the coated film layer onto the current collector can be used herein. Some non-limiting examples of equipment that can be used to heat and/or dry the coated film include a batch drying oven, a conveyor drying oven, and a microwave drying oven. Some non-limiting examples of the conveyor drying oven include a conveyor hot air-drying oven, a conveyor resistance drying oven, a conveyor inductive drying oven, and a conveyor microwave drying oven. When the coated film is manufactured using a dry electrode mixture, the initial liquid content is already negligible, so drying might not be necessary. However, heating could still be required or advantageous to ensure that the coated film is securely fixed to the current collector. Even if the coated film is manufactured with a dry electrode mixture, it can still be dried to further decrease the liquid content of the coated film.

There are no particular limitations on the conditions used to heat and/or dry the coated film, except that following the heating and/or drying process, the coated film should be securely fixed to the current collector without deformation or delamination. Therefore, the temperature should be sufficiently high to ensure that the heating and/or drying process can be completed within a reasonable timeframe. At the same time, the temperature should be sufficiently low to ensure that the electrode components in the coated electrode film do not degrade from the heat, and to reduce the risk of significant temperature gradients caused by uneven heating, which may cause deformation or delamination of the electrode.

In some embodiments, the coated film on the current collector is heated to and/or dried at a temperature of from about 50° C. to about 160° C., from about 60° C. to about 160° C., from about 70° C. to about 160° C., from about 80° C. to about 160° C., from about 90° C. to about 160° C., from about 95° C. to about 160° C., from about 100° C. to about 160° C., from about 105° C. to about 160° C., from about 110° C. to about 160° C., from about 115° C. to about 160° C., from about 120° C. to about 160° C., from about 125° C. to about 160° C., from about 130° C. to about 160° C., from about 140° C. to about 160° C., from about 60° C. to about 150° C., from about 70° C. to about 150° C., from about 80° C. to about 150° C., from about 90° C. to about 150° C., from about 95° C. to about 150° C., from about 100° C. to about 150° C., from about 105° C. to about 150° C., from about 110° C. to about 150° C., from about 115° C. to about 150° C., from about 120° C. to about 150° C., from about 60° C. to about 140° C., from about 70° C. to about 140° C., from about 80° C. to about 140° C., from about 90° C. to about 140° C., from about 95° C. to about 140° C., from about 100° C. to about 140° C., from about 105° C. to about 140° C., from about 110° C. to about 140° C., from about 115° C. to about 140° C., from about 120° C. to about 140° C., from about 60° C. to about 130° C., from about 70° C. to about 130° C., from about 80° C. to about 130° C., from about 90° C. to about 130° C., from about 95° C. to about 130° C., from about 100° C. to about 130° C., from about 105° C. to about 130° C., from about 110° C. to about 130° C., from about 60° C. to about 120° C., from about 70° C. to about 120° C., from about 80° C. to about 120° C., from about 90° C. to about 120° C., from about 95° C. to about 120° C., from about 100° C. to about 120° C., from about 60° C. to about 110° C., from about 70° C. to about 110° C., from about 80° C. to about 110° C., from about 90° C. to about 110° C., from about 60° C. to about 100° C., from about 70° C. to about 100° C., or from about 80° C. to about 100° C.

In some embodiments, the coated film on the current collector is heated to and/or dried at a temperature of less than 160° C., less than 150° C., less than 140° C., less than 130° C., less than 120° C., less than 115° C., less than 110° C., less than 105° C., less than 100° C., less than 95° C., less than 90° C., less than 80° C., or less than 70° C. In some embodiments, the coated film on the current collector is heated to and/or dried at a temperature of more than 60° C., more than 70° C., more than 80° C., more than 90° C., more than 95° C., more than 100° C., more than 105° C., more than 110° C., more than 115° C., more than 120° C., more than 130° C., or more than 140° C.

After heating and/or drying, the electrode layer is formed. In some embodiments, the electrode layer is compressed mechanically following heating and/or drying in order to enhance the density of the electrode layer. In some embodiments, when the coated film comprises cathode active material, the electrode layer is specifically a cathode electrode layer. In some embodiments, when the coated film comprises anode active material, the electrode layer is specifically an anode electrode layer.

The proportion of binder copolymer in the electrode layer can be the same as the proportion of binder copolymer in the dry electrode mixture or the solid portion of the electrode slurry, as described above. Likewise, the respective proportions of conductive agent and electrode active material in the electrode layer can be the same as the respective proportions of conductive agent and electrode active material in the dry electrode mixture or the solid portion of the electrode slurry, as described above.

In certain embodiments, the thickness of the electrode layer is from about 5 µm to about 90 µm, from about 5 µm to about 50 µm, from about 5 µm to about 25 µm, from about 10 µm to about 90 µm, from about 10 µm to about 50 µm, from about 10 µm to about 30 µm, from about 15 µm to about 90 µm, from about 20 µm to about 90 µm, from about 25 µm to about 90 µm, from about 25 µm to about 80 µm, from about 25 µm to about 70 µm, from about 25 µm to about 50 µm, from about 30 µm to about 90 µm, or from about 30 µm to about 80 µm. In some embodiments, the thickness of the electrode layer is more than 5 µm, more than 10 µm, more than 15 µm, more than 20 µm, more than 25 µm, more than 30 µm, more than 40 µm, more than 50 µm, more than 60 µm, more than 70 µm, or more than 80 µm. In some embodiments, the thickness of the electrode layer is less than 90 µm, less than 80 µm, less than 70 µm, less than 60 µm, less than 50 µm, less than 40 µm, less than 30 µm, less than 25 µm, less than 20 µm, less than 15 µm, or less than 10 µm.

In some embodiments, the surface density of the electrode layer is from about 1 mg/cm² to about 50 mg/cm², from about 3 mg/cm² to about 50 mg/cm², from about 5 mg/cm² to about 50 mg/cm², from about 10 mg/cm² to about 50 mg/cm², from about 15 mg/cm² to about 50 mg/cm², from about 20 mg/cm² to about 50 mg/cm², from about 30 mg/cm² to about 50 mg/cm², from about 1 mg/cm² to about 30 mg/cm², from about 3 mg/cm² to about 30 mg/cm², from about 5 mg/cm² to about 30 mg/cm², from about 10 mg/cm² to about 30 mg/cm², from about 15 mg/cm² to about 30 mg/cm², from about 20 mg/cm² to about 30 mg/cm², from about 1 mg/cm² to about 20 mg/cm², from about 3 mg/cm² to about 20 mg/cm², from about 5 mg/cm² to about 20 mg/cm², from about 10 mg/cm² to about 20 mg/cm², from about 1 mg/cm² to about 15 mg/cm², from about 3 mg/cm² to about 15 mg/cm², from about 5 mg/cm² to about 15 mg/cm², or from about 10 mg/cm² to about 15 mg/cm².

In some embodiments, the surface density of the electrode layer is less than 50 mg/cm², less than 40 mg/cm², less than 30 mg/cm², less than 20 mg/cm², less than 15 mg/cm², less than 10 mg/cm², less than 5 mg/cm², or less than 3 mg/cm². In some embodiments, the surface density of the electrode layer is more than 1 mg/cm², more than 3 mg/cm², more than 5 mg/cm², more than 10 mg/cm², more than 15 mg/cm², more than 20 mg/cm², more than 30 mg/cm², or more than 40 mg/cm².

In some embodiments, the density of the electrode layer is from about 0.5 g/cm³ to about 7.5 g/cm³, from about 1 g/cm³ to about 7.5 g/cm³, from about 1.5 g/cm³ to about 7.5 g/cm³, from about 2 g/cm³ to about 7.5 g/cm³, from about 2.5 g/cm³ to about 7.5 g/cm³, from about 3.5 g/cm³ to about 7.5 g/cm³, from about 4.5 g/cm³ to about 7.5 g/cm³, from about 0.5 g/cm³ to about 5.5 g/cm³, from about 1 g/cm³ to about 5.5 g/cm³, from about 1.5 g/cm³ to about 5.5 g/cm³, from about 2 g/cm³ to about 5.5 g/cm³, from about 2.5 g/cm³ to about 5.5 g/cm³, from about 0.5 g/cm³ to about 2.5 g/cm³, from about 1 g/cm³ to about 2.5 g/cm³, or from about 1.5 g/cm³ to about 2.5 g/cm³. In some embodiments, the density of the electrode layer is less than 7.5 g/cm³, less than 6.5 g/cm³, less than 5.5 g/cm³, less than 4.5 g/cm³, less than 3.5 g/cm³, less than 2.5 g/cm³, less than 2 g/cm³, or less than 1.5 g/cm³. In some embodiments, the density of the electrode layer is more than 0.5 g/cm³, more than 1 g/cm³, more than 1.5 g/cm³, more than 2 g/cm³, more than 2.5 g/cm³, more than 3.5 g/cm³, more than 4.5 g/cm³, or more than 5.5 g/cm³.

In addition, an electrode prepared via a dry electrode mixture or electrode slurry produced using a binder composition of the present invention exhibits strong adhesion of the electrode layer to the current collector. It is important for the electrode layer to have good peeling strength to the current collector as this prevents delamination or separation of the electrode, which would greatly influence the mechanical stability of the electrodes and the cyclability of the battery. Therefore, the electrodes should have sufficient peeling strength to withstand the rigors of battery manufacture.

In some embodiments, the peeling strength between the current collector and the electrode layer is from about 1.0 N/cm to about 8.0 N/cm, from about 1.0 N/cm to about 6.0 N/cm, from about 1.0 N/cm to about 5.0 N/cm, from about 1.0 N/cm to about 4.0 N/cm, from about 1.0 N/cm to about 3.0 N/cm, from about 1.0 N/cm to about 2.5 N/cm, from about 1.0 N/cm to about 2.0 N/cm, from about 1.2 N/cm to about 3.0 N/cm, from about 1.2 N/cm to about 2.5 N/cm, from about 1.2 N/cm to about 2.0 N/cm, from about 1.5 N/cm to about 3.0 N/cm, from about 1.5 N/cm to about 2.5 N/cm, from about 1.5 N/cm to about 2.0 N/cm, from about 1.8 N/cm to about 3.0 N/cm, from about 1.8 N/cm to about 2.5 N/cm, from about 2.0 N/cm to about 6.0 N/cm, from about 2.0 N/cm to about 5.0 N/cm, from about 2.0 N/cm to about 3.0 N/cm, from about 2.0 N/cm to about 2.5 N/cm, from about 2.2 N/cm to about 3.0 N/cm, from about 2.5 N/cm to about 3.0 N/cm, from about 3.0 N/cm to about 8.0 N/cm, from about 3.0 N/cm to about 6.0 N/cm, or from about 4.0 N/cm to about 6.0 N/cm.

In some embodiments, the peeling strength between the current collector and the electrode layer is more than 1.0 N/cm, more than 1.2 N/cm, more than 1.5 N/cm, more than 2.0 N/cm, more than 2.2 N/cm, more than 2.5 N/cm, more than 3.0 N/cm, more than 3.5 N/cm, more than 4.0 N/cm, more than 4.5 N/cm, more than 5.0 N/cm, more than 5.5 N/cm, more than 6.0 N/cm, more than 6.5 N/cm, or more than 7.0 N/cm. In some embodiments, the peeling strength between the current collector and the electrode layer is less than 8.0 N/cm, less than 7.5 N/cm, less than 7 N/cm, less than 6.5 N/cm, less than 6.0 N/cm, less than 5.5 N/cm, less than 5.0 N/cm, less than 4.5 N/cm, less than 4.0 N/cm, less than 3.5 N/cm, less than 3.0 N/cm, less than 2.8 N/cm, less than 2.5 N/cm, less than 2.2 N/cm, less than 2.0 N/cm, less than 1.8 N/cm, or less than 1.5 N/cm.

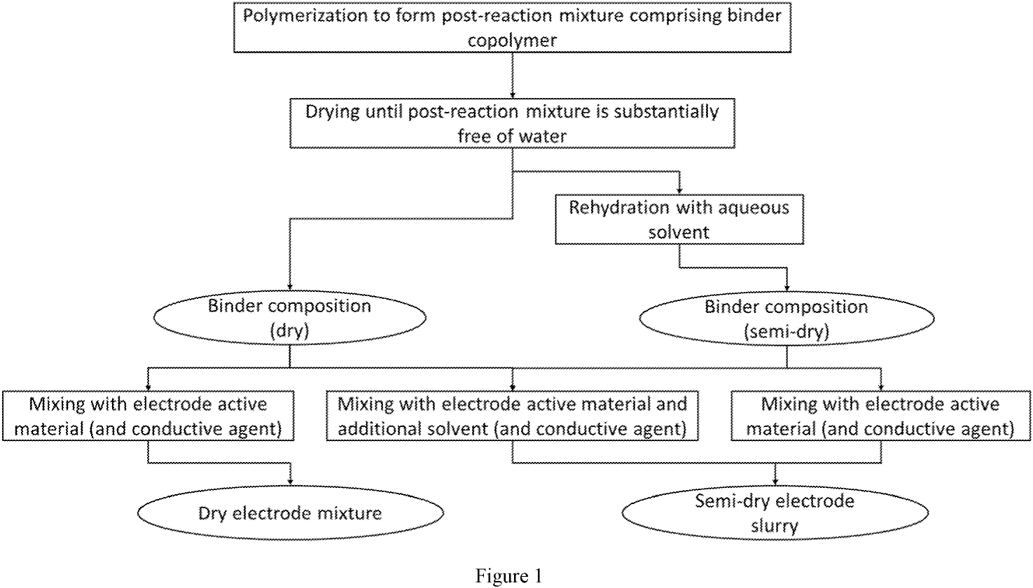

FIG. 1 shows a flow chart illustrating a simplified summary of some embodiments of the various aspects of the invention disclosed herein. As shown, following polymerization, the post-reaction mixture is dried until it is substantially free of water. When the desired binder composition is a dry binder composition, the dried post-reaction mixture is the binder composition. When the desired binder composition is a semi-dry binder composition, the dried post-reaction mixture is instead rehydrated to form the binder composition. To form a dry electrode mixture from a dry binder composition, the dry binder composition is mixed with an electrode active material and optionally a conductive agent. To form a semi-dry electrode slurry from a dry binder composition, the dry binder composition is mixed with an electrode active material and additional solvent, and optionally a conductive agent. To form a semi-dry electrode slurry from a semi-dry binder composition, the semi-dry binder composition is mixed with an electrode active material, and optionally a conductive agent and/or additional solvent.

The binder composition disclosed herein has multiple advantages. Most importantly, compared to a conventional wet binder composition, the lower liquid content of the binder composition disclosed herein ensures that greater efficiency in storage and transport of the binder composition can be achieved, thereby helping to streamline the supply chain of electrode manufacturing. The dry binder composition disclosed herein was found to be able to be directly used in a dry electrode mixture, as well as in an electrode slurry after being rehydrated into a semi-dry binder composition. In both cases, batteries comprising electrodes produced using the dry or semi-dry binder composition disclosed herein were found to have similar mechanical and electrochemical performances compared to batteries comprising electrodes produced using a conventional wet binder composition. Overall, this shows that the binder composition disclosed herein has excellent binder performance, and that the binder copolymer within the binder composition disclosed herein is effective both in a dry state as well as in a rehydrated form, thereby showing the versatility of the copolymer.

The following examples are presented to exemplify embodiments of the invention but are not intended to limit the invention to the specific embodiments set forth. Unless indicated to the contrary, all parts and percentages are by weight. All numerical values are approximate. When numerical ranges are given, it should be understood that embodiments outside the stated ranges may still fall within the scope of the invention. Specific details disclosed in each example should not be construed as necessary features of the invention.

### EXAMPLES

The peeling strengths of the electrode layers were measured by a tensile testing machine (DZ-106A, obtained from Dongguan Zonhow Test Equipment Co. Ltd., China). This test measures the average force required to peel an electrode layer from the current collector at 180 ° angle in newtons. The mean roughness depth (R_{z}) of the current collector is 2 µm. A strip of adhesion tape (3 M; US; model no. 810) with a width of 18 mm and a length of 20 mm was attached onto the surface of the electrode layer. The electrode strip was clipped onto the testing machine, and the tape was folded back on itself at 180 degrees, then placed in a moveable jaw and pulled at room temperature and a peel rate of 200 mm per minute. The maximum stripping force measured was taken as the peeling strength. Measurements were repeated three times to find the average value.

The solid content of the binder composition, dry electrode mixture or electrode slurry was calculated from the change in mass of the binder composition, dry electrode mixture or electrode slurry before and after drying. Approximately 1 g of the binder composition, dry electrode mixture or electrode slurry was weighed in a weighing bottle and dried at 110 ± 5° C. and -0.09 MPa for more than 5 hours by a vacuum dryer. The dried binder composition, dry electrode mixture or electrode slurry was cooled in a desiccator for about 15 minutes and its mass was measured. The difference in mass of the binder composition, dry electrode mixture or electrode slurry before and after drying was determined, and the solid content of the binder composition, dry electrode mixture or electrode slurry was calculated according to the following formula:

$$\text{Solid content of x} = \frac{\text{Mass of x after drying}}{\text{Mass of x before drying}} \times 100 \%$$

wherein x may refer to the binder composition, dry electrode mixture, or electrode slurry.

The weight-average molecular weight and number-average molecular weight of the water-compatible copolymer were measured by gel permeation chromatography. A binder composition comprising the copolymer was first dissolved in dimethylformamide at room temperature. Once dissolution of the binder composition was complete, the solution was gently filtered through a 0.45 µm filter to prepare a measurement sample. A polystyrene standard was used to prepare a calibration curve against which the weight-average molecular weight and the number-average molecular weight of the copolymer were calculated. The obtained measurement sample was analyzed with an Agilent PLgel 5um MIXED-C column. The flow rate was 1 ml/min and the weight of the sample was 2 mg. The detector used was Waters 2414 Refractive Index (RI) Detector and the detection temperature was 35° C.

### Example 1

### A) Preparation of Binder Composition

17.96 g of sodium hydroxide (NaOH) was added into a round-bottom flask containing 380 g of distilled water. The mixture was stirred at 80 rpm for 30 mins to obtain a first suspension.

35.67 g of acrylic acid was added into the first suspension. The mixture was further stirred at 80 rpm for 30 mins to obtain a second suspension.

18.84 g of acrylamide was dissolved in 10 g of DI water to form an acrylamide solution. Thereafter, all of the acrylamide solution was added into the second suspension. The mixture was further heated to 55° C. and stirred at 80 rpm for 45 mins to obtain a third suspension.

12.73 g of acrylonitrile was added into the third suspension. The mixture was further stirred at 80 rpm for 10 mins to obtain a fourth suspension.

Further, 0.015 g of water-soluble free radical initiator (ammonium persulfate, APS; obtained from Aladdin Industries Corporation, China) was dissolved in 3 g of DI water and 0.0075 g of reducing agent (sodium bisulfite; obtained from Tianjin Damao Chemical Reagent Factory, China) was dissolved in 1.5 g of DI water. All of the APS solution and the sodium bisulfite solution were added into the fourth suspension. The mixture was stirred at 200 rpm for 24 h at 55° C. to obtain a fifth suspension.

After the complete reaction, the temperature of the fifth suspension was lowered to 25° C. 3.72 g of NaOH was dissolved in 400 g of DI water and all of this sodium hydroxide solution was added dropwise into the fifth suspension to adjust pH to 7.3 and form a sixth suspension. The sixth suspension was filtered using 200 µm nylon mesh. The solid content of the filtered sixth suspension was 9.00 wt.%.

The filtered sixth suspension was dried in a vacuum dryer overnight at 60° C., then ground using a mortar and pestle to form a dry binder composition in the form of a fine powder. The weight-average molecular weight, number-average molecular weight and polydispersity index of the binder composition was 140,300 g/mol, 61,500 g/mol, and 2.28 respectively.

### B) Preparation of Positive Electrode

0.9 g of conductive agent (KS6; obtained from ANR Technologies Pte. Ltd., Singapore), 0.90 g of the binder composition, and 28.2 g of NMC532 (obtained from Shandong Tianjiao New Energy Co., Ltd, China) were first ground using a mill to form a homogeneous mixture. Subsequently, 20.0 g of DI water was added to the mixture, then further milling was conducted to form a homogenized cathode slurry. The solid content of the cathode slurry was 60 wt.%.

The cathode slurry was coated onto one side of an aluminum foil having a thickness of 16 µm as a current collector. The coated film on the aluminum foil was dried at about 80° C. for 120 minutes by a hot air dryer (DHG 10H, Huyue Equipment Co., Ltd., China) to form a cathode electrode layer. The electrode was then pressed to decrease the thickness and the surface density of the cathode electrode layer to 34 µm and 5 mg/cm² respectively.

### C) Assembling of Coin Cell

CR2032 coin-type Li cells were assembled in an argon-filled glove box. The coated cathode sheet was cut into a disc-form positive electrode. Lithium metal foil having a thickness of 500 µm was used as a negative electrode. The cathode and anode were kept apart by a separator. The separator was a ceramic coated microporous membrane made of nonwoven fabric (MPM, Japan), which had a thickness of about 25 µm. The electrode assembly was dried in a box-type resistance oven under vacuum (DZF-6020, obtained from Shenzhen Kejing Star Technology Co. Ltd., China) at 105° C. for about 16 hours. The water content of the separator and electrode assembly after drying was 200 ppm and 300 ppm respectively.

An electrolyte was then injected into the case holding the packed electrodes under a high-purity argon atmosphere with a moisture and oxygen content of less than 3 ppm respectively. The electrolyte was a solution of LiPF₆ (1 M) in a mixture of ethylene carbonate (EC), ethyl methyl carbonate (EMC) and dimethyl carbonate (DMC) at a volume ratio of 1:1:1. After electrolyte filling, the coin cell was mechanically pressed using a punch tooling with a standard circular shape.

### D) Electrochemical Measurements

The coin cells were analyzed in a constant current mode using a multi-channel battery tester (BTS-4008-5 V10 mA, obtained from Neware Electronics Co. Ltd, China). The first cycle was completed at C/20, performed between 3.0 and 4.3 V at 25° C., with the corresponding discharging capacity of the cycle measured. The electrochemical performance of the coin cells of Example 1 were measured and are shown in Table 1 below.

### Example 2

A positive electrode was prepared in the same manner as Example 1, except that when preparing the binder composition, 7.45 g of sodium hydroxide was added in the preparation of the first suspension, 16.77 g of acrylic acid was added in the preparation of the second suspension, 7.19 g of acrylamide was added in the preparation of the third suspension, and 35.55 g of acrylonitrile was added in the preparation of the fourth suspension. The solid content of the filtered sixth suspension was 8.88 wt.%. The weight-average molecular weight, number-average molecular weight and polydispersity index of the binder composition was 160,900 g/mol, 71,000 g/mol, and 2.27 respectively.

### Example 3

A positive electrode was prepared in the same manner as Example 1, except that when preparing the binder composition, 30.10 g of sodium hydroxide was added in the preparation of the first suspension, 56.92 g of acrylic acid was added in the preparation of the second suspension, 7.19 g of acrylamide was added in the preparation of the third suspension, and 5.90 g of acrylonitrile was added in the preparation of the fourth suspension. The solid content of the filtered sixth suspension was 9.82 wt.%.

### Example 4

A positive electrode was prepared in the same manner as Example 1, except that when preparing the binder composition, 5.02 g of sodium hydroxide was added in the preparation of the first suspension, 12.39 g of acrylic acid was added in the preparation of the second suspension, 23.73 g of acrylamide was added in the preparation of the third suspension, and 26.84 g of acrylonitrile was added in the preparation of the fourth suspension. The solid content of the filtered sixth suspension was 8.64 wt.%.

### Example 5

A positive electrode was prepared in the same manner as Example 1, except that when preparing the binder composition, 11.90 g of sodium hydroxide was added in the preparation of the first suspension, 24.50 g of acrylic acid was added in the preparation of the second suspension, 7.19 g of acrylamide was added in the preparation of the third suspension, and 29.71 g of acrylonitrile was added in the preparation of the fourth suspension. The solid content of the filtered sixth suspension was 8.38 wt.%.

### Example 6

A positive electrode was prepared in the same manner as Example 1, except that when preparing the binder composition, 3.00 g of sodium hydroxide was added in the preparation of the first suspension, 8.75 g of acrylic acid was added in the preparation of the second suspension, 7.19 g of acrylamide was added in the preparation of the third suspension, and 41.86 g of acrylonitrile was added in the preparation of the fourth suspension. The solid content of the filtered sixth suspension was 7.22 wt.%.

### Example 7

### A) Preparation of Binder Composition

A binder composition was prepared in the same manner as Example 1, except that following the drying and grinding of the filtered sixth suspension, DI water was mixed with the resultant dry powder to produce the binder composition, such that the mass ratio of DI water to dry powder was 1:2. The binder composition was a semi-dry binder composition with a liquid content of 33.3 wt.%.

### B) Preparation of Positive Electrode

A positive electrode was prepared in the same manner as Example 1, except that 1.35 g of the above binder composition (33.3 wt.% liquid content) and 19.55 g of DI water was added in the preparation of the homogeneous cathode slurry.

### Example 8

### A) Preparation of Binder Composition

A binder composition was prepared in the same manner as Example 1, except that following drying and grinding of the filtered sixth suspension, DI water was mixed with the resultant dry powder to produce the binder composition, such that the mass ratio of DI water to dry powder was 1:1. The binder composition was a semi-dry binder composition with a liquid content of 50 wt.%.

### B) Preparation of Positive Electrode

A positive electrode was prepared in the same manner as Example 1, except that 1.80 g of the above binder composition (50 wt.% liquid content) and 19.10 g of DI water was added in the preparation of the homogeneous cathode slurry.

### Example 9

### A) Preparation of Binder Composition

A binder composition was prepared in the same manner as Example 1, except that following drying and grinding of the filtered sixth suspension, DI water was mixed with the resultant dry powder to produce the binder composition, such that the mass ratio of DI water to dry powder was 2:1. The binder composition was a semi-dry binder composition with a liquid content of 66.7 wt.%.

### B) Preparation of Positive Electrode

A positive electrode was prepared in the same manner as Example 1, except that 2.70 g of the above binder composition (66.7 wt.% liquid content) and 18.20 g of DI water was added in the preparation of the homogeneous cathode slurry.

### Example 10

### A) Preparation of Binder Composition

A binder composition was prepared in the same manner as Example 1, except that following drying and grinding of the filtered sixth suspension, DI water was mixed with the resultant dry powder to produce the binder composition, such that the mass ratio of DI water to dry powder was 4:1. The binder composition was a semi-dry binder composition with a liquid content of 80 wt.%.

### B) Preparation of Positive Electrode

A positive electrode was prepared in the same manner as Example 1, except that 4.50 g of the above binder composition (80 wt.% liquid content) and 17.30 g of DI water was added in the preparation of the homogeneous cathode slurry.

### Example 11

### A) Preparation of Binder Composition

A binder composition was prepared in the same manner as Example 1.

### B) Preparation of Positive Electrode

0.24 g of conductive agent (KS6; obtained from ANR Technologies Pte. Ltd., Singapore), 0.36 g of the binder composition, and 0.60 g of NMC532 (obtained from Shandong Tianjiao New Energy Co., Ltd, China), were grinded using a mill to form a homogenized dry cathode mixture.

0.2 g of the homogenized cathode mixture was pressed onto one side of an aluminum foil having a thickness of 16 µm as a current collector using a hot press. The coated film on the aluminum foil was vacuum dried at about 80° C. for 6 hours to form a cathode electrode layer.

### Example 12

A positive electrode was prepared in the same manner as Example 11, except that the binder composition used was prepared in the same manner as Example 2.

### Example 13

A positive electrode was prepared in the same manner as Example 1, except that the NMC532 was replaced with LCO of the same weight.

### Example 14

A positive electrode was prepared in the same manner as Example 1, except that the NMC532 was replaced with LFP (Tianjin Sitelan Energy Technology Co. Ltd., China) of the same weight.

### Assembly of Coin Cells of Examples 2-14

The coin cells of Examples 2-14 were assembled in the same manner as Example 1.

### Electrochemical Measurements of Examples 2-13

The coin cells of Examples 2-13 were analyzed in the same manner as Example 1. The electrochemical performances of the coin cells of Examples 2-13 were measured and are shown in Table 1 below.

### Electrochemical Measurements of Example 14

The coin cells of Example 14 were analyzed in the same manner as Example 1, except that cycling was performed between 2.0 and 3.65 V. The electrochemical performances of the coin cells of Examples 14 were measured and are shown in Table 1 below.

### Comparative Example 1

A positive electrode was prepared in the same manner as Example 1, except that 0.9 g of dry sodium polyacrylate (Sigma-Aldrich, Germany) was used as the binder composition.

### Comparative Example 2

A positive electrode was prepared in the same manner as Example 1, except that 0.9 g of dry polyacrylamide (Sigma-Aldrich, Germany) was used as the binder composition.

### Comparative Example 3

A positive electrode was prepared in the same manner as Example 1, except that 0.9 g of dry polyacrylonitrile (Sigma-Aldrich, Germany) was used as the binder composition.

### Comparative Example 4

A positive electrode was prepared in the same manner as Example 1, except that when preparing the binder composition, 24.14 g of sodium hydroxide was added in the preparation of the first suspension, 46.84 g of acrylic acid was added in the preparation of the second suspension, acrylamide was not added in the preparation of the third suspension, and 18.57 g of acrylonitrile was added in the preparation of the fourth suspension. The solid content of the filtered sixth suspension was 9.63 wt.%.

### Comparative Example 5

A positive electrode was prepared in the same manner as Example 1, except that when preparing the binder composition, 26.13 g of sodium hydroxide was added in the preparation of the first suspension, 50.44 g of acrylic acid was added in the preparation of the second suspension, 21.32 g of acrylamide was added in the preparation of the third suspension, and acrylonitrile was not added in the preparation of the fourth suspension. The solid content of the filtered sixth suspension was 9.92 wt.%.

### Comparative Example 6

A positive electrode was prepared in the same manner as Example 1, except that when preparing the binder composition, 1.86 g of sodium hydroxide was added in the preparation of the first suspension, acrylic acid was not added in the preparation of the second suspension, 21.32 g of acrylamide was added in the preparation of the third suspension, 37.14 g of acrylonitrile was added in the preparation of the fourth suspension, and sodium hydroxide was not added in the preparation of the sixth suspension. The solid content of the filtered sixth suspension was 7.15 wt.%.

### Comparative Example 7

### A) Preparation of Binder Composition

A binder composition was prepared in the same manner as Comparative Example 4, except that following drying and grinding of the filtered sixth suspension, DI water was mixed with the resultant dry powder to produce the binder composition, such that the mass ratio between the DI water and the dry powder was 2:1. The binder composition was a semi-dry binder composition with a liquid content of 66.7 wt.%.

### B) Preparation of Positive Electrode

A positive electrode was prepared in the same manner as Example 1, except that 2.70 g of the above binder composition (66.7 wt.% liquid content) and 18.20 g of DI water was added in the preparation of the homogeneous cathode slurry.

### Comparative Example 8

A positive electrode was prepared in the same manner as Example 11, except that 0.9 g of dry sodium polyacrylate (Sigma-Aldrich, Germany) was used as the binder composition.

### Comparative Example 9

A positive electrode was prepared in the same manner as Example 11, except that 0.9 g of dry polyacrylamide (Sigma-Aldrich, Germany) was used as the binder composition.

### Comparative Example 10

A positive electrode was prepared in the same manner as Example 11, except that 0.9 g of dry polyacrylonitrile (Sigma-Aldrich, Germany) was used as the binder composition.

### Comparative Example 11

A positive electrode was prepared in the same manner as Example 11, except that the binder composition was prepared in the same manner as Comparative Example 4.

### Comparative Example 12

A positive electrode was prepared in the same manner as Example 11, except that the binder composition was prepared in the same manner as Comparative Example 5.

### Comparative Example 13

A positive electrode was prepared in the same manner as Example 11, except that the binder composition was prepared in the same manner as Comparative Example 6.

### Assembly of Coin Cells of Comparative Examples 1-13

The coin cells of Comparative Examples 1-13 were assembled in the same manner as Example 1.

### Electrochemical Measurements of Comparative Examples 1-13

The coin cells of Comparative Examples 1-13 were analyzed in the same manner as Example 1. The electrochemical performances of the coin cells of Comparative Examples 1-13 were measured and are shown in Table 2 below.

While the invention has been described with respect to a limited number of embodiments, the specific features of one embodiment should not be attributed to other embodiments of the invention. In some embodiments, the methods may include numerous steps not mentioned herein. In other embodiments, the methods do not include, or are substantially free of, any steps not enumerated herein. Variations and modifications from the described embodiments exist. The appended claims intend to cover all those modifications and variations as falling within the scope of the invention.

TABLE 1

| | Proportion of structural units in binder copolymer (mol%) | | | Cathode active material | Electrode mixture / Binder composition electrode slurry liquid content (%) liquid content (%) | | 0.05 C Initial discharging capacity (mAh/g) |
|---|---|---|---|---|---|---|---|
| | Derived from structural unit (a) | Derived from structural unit (b) | Derived from structural unit (c) | | | | |
| Example 1 | 49.5 | 26.5 | 24 | NMC532 | 0* | 40 | 167.4 |
| Example 2 | 23 | 10 | 67 | NMC532 | 0* | 40 | 168.8 |
| Example 3 | 79 | 10 | 11 | NMC532 | 0* | 40 | 163.4 |
| Example 4 | 17 | 33 | 50 | NMC532 | 0* | 40 | 166.0 |
| Example 5 | 34 | 10 | 56 | NMC532 | 0* | 40 | 168.2 |
| Example 6 | 12 | 10 | 78 | NMC532 | 0* | 40 | 168.3 |
| Example 7 | 49.5 | 26.5 | 24 | NMC532 | 33.3 | 40 | 165.2 |
| Example 8 | 49.5 | 26.5 | 24 | NMC532 | 50 | 40 | 164.2 |
| Example 9 | 49.5 | 26.5 | 24 | NMC532 | 66.7 | 40 | 165.8 |
| Example 10 | 49.5 | 26.5 | 24 | NMC532 | 80 | 40 | 169.2 |
| Example 11 | 49.5 | 26.5 | 24 | NMC532 | 0* | 0* | 166.4 |
| Example 12 | 23 | 10 | 67 | NMC532 | 0* | 0* | 169.8 |
| Example 13 | 49.5 | 26.5 | 24 | LCO | 0* | 40 | 174.4 |
| Example 14 | 49.5 | 26.5 | 24 | LFP | 0* | 40 | 138.2 |

*: The binder composition and/or electrode mixture / electrode slurry was substantially free of liquid.

TABLE 2

| | Proportion of structural units in binder copolymer (mol%) | | | Cathode active material | Binder composition liquid content (%) | Electrode mixture / electrode slurry liquid content (%) | 0.05 C Initial discharging capacity (mAh/g) |
|---|---|---|---|---|---|---|---|
| | Derived from structural unit (a) | Derived from structural unit (b) | Derived from structural unit (c) | | | | |
| Comparative Example 1 | 100 | 0 | 0 | NMC532 | 0* | 40 | 149.5 |
| Comparative Example 2 | 0 | 100 | 0 | NMC532 | 0* | 40 | -^{#} |
| Comparative Example 3 | 0 | 0 | 100 | NMC532 | 0* | 40 | -^{#} |
| Comparative Example 4 | 65 | 0 | 35 | NMC532 | 0* | 40 | 144.6 |
| Comparative Example 5 | 70 | 30 | 0 | NMC532 | 0* | 40 | 132.5 |
| Comparative Example 6 | 0 | 30 | 70 | NMC532 | 0* | 40 | 129.1 |
| Comparative Example 7 | 65 | 0 | 35 | NMC532 | 66.7 | 40 | 135.0 |
| Comparative Example 8 | 100 | 0 | 0 | NMC532 | 0* | 0* | -^{#} |
| Comparative Example 9 | 0 | 100 | 0 | NMC532 | 0* | 0* | -^{#} |
| Comparative Example 11 | 65 | 0 | 35 | NMC532 | 0* | 0* | -^{#} |
| Comparative Example 12 | 70 | 30 | 0 | NMC532 | 0* | 0* | -^{#} |
| Comparative Example 13 | 0 | 30 | 70 | NMC532 | 0* | 0* | -^{#} |

*: The binder composition and/or electrode mixture / electrode slurry was substantially free of liquid.
^{#:} A viable battery could not be produced.

1. A binder composition comprising a water-compatible copolymer, wherein the binder composition has a liquid content of less than 85% by weight, based on the total weight of the binder composition.

2. The binder composition according to claim 1, wherein the binder composition has a liquid content of less than 50% or less than 25% by weight, based on the total weight of the binder composition.

3. The binder composition according to claim 1, wherein the binder composition has a liquid content of less than 1% by weight, based on the total weight of the binder composition.

4. The binder composition according to claim 1, wherein the water-compatible copolymer comprises a structural unit (a) that is derived from an acid group-containing monomer, wherein the acid group is selected from the group consisting of carboxylic acid, sulfonic acid, sulfuric acid, phosphonic acid, phosphoric acid, nitric acid, salts of these acids, derivatives of these acids, and combinations thereof, and wherein the proportion of structural unit (a) within the copolymer is from about 5% to about 95% by mole, based on the total number of moles of monomeric units in the copolymer.

5. The binder composition according to claim 1, wherein the water-compatible copolymer further comprises a structural unit (b) that is derived from a monomer selected from the group consisting of an amide group-containing monomer, a hydroxyl group-containing monomer, and combinations thereof, and wherein the proportion of structural unit (b) within the copolymer is from about 5% to about 90% by mole, based on the total number of moles of monomeric units in the copolymer.

6. The binder composition according to claim 1, where in the water-compatible copolymer further comprises a structural unit (c) that is derived from a monomer selected from the group consisting of a nitrile group-containing monomer, an ester group-containing monomer, an ether group-containing monomer, an epoxy group-containing monomer, a carbonyl group-containing monomer, a fluorine-containing monomer, and combinations thereof, and wherein the proportion of structural unit (c) within the copolymer is from about 10% to about 95% by mole, based on the total number of moles of monomeric units in the copolymer.

7. The binder composition according to claim 1, wherein the liquid content is derived from an aqueous solvent.

8. The binder composition according to claim 7, wherein the aqueous solvent comprises water.

9. The binder composition according to claim 1, wherein the weight-average molecular weight of the water-compatible copolymer in the binder composition is from about 10,000 g/mol to about 1,000,000 g/mol.

10. The binder composition according to claim 1, wherein the number-average molecular weight of the water-compatible copolymer in the binder composition is from about 10,000 g/mol to about 500,000 g/mol.

11. The binder composition according to claim 1, wherein the polydispersity index of the water-compatible copolymer in the binder composition is from about 1 to about 20.

12. An electrode slurry comprising the binder composition of claim 1 and an electrode active material, wherein the electrode slurry has a liquid content of from about 1% to about 60% by weight, based on the total weight of the electrode slurry.

13. The electrode slurry according to claim 12, wherein the electrode slurry further comprises a conductive agent.

14. The electrode slurry according to claim 12, wherein the liquid content of the electrode slurry is derived from an aqueous solvent.

15. The electrode slurry according to claim 14, wherein the aqueous solvent comprises water.

16. The electrode slurry according to claim 12, wherein the proportion of electrode active material in the solid portion of the electrode slurry is from about 40% to about 99% by weight, based on the total weight of the solid portion of the electrode slurry.

17. A dry electrode mixture comprising the binder composition of claim 3 and an electrode active material.

18. The dry electrode mixture according to claim 17, wherein the dry electrode mixture further comprises a conductive agent.

19. The dry electrode mixture according to claim 17, wherein the proportion of electrode active material in the dry electrode mixture is from about 40% to about 99% by weight, based on the total weight of the dry electrode mixture.

20. The dry electrode mixture according to claim 17, wherein the dry electrode mixture has a liquid content of less than 1% by weight, based on the total weight of the dry electrode mixture.
